(19) United States
(12) Patent Application Publication
(10) Pub. No.: US 2013/0063487 A1
(43) Pub. Date: Mar. 14, 2013

(54) METHOD AND SYSTEM OF USING AUGMENTED REALITY FOR APPLICATIONS

(71) Applicants: Ehud SPIEGEL, Petach-Tikva (IL); Yoram ELICHAI, Ashdod (IL); Pinhas SABACH, Jerusalem (IL); Andrew FRUCHTER, New York, NY (US)

(72) Inventors: Ehud SPIEGEL, Petach-Tikva (IL); Yoram ELICHAI, Ashdod (IL); Pinhas SABACH, Jerusalem (IL); Andrew FRUCHTER, New York, NY (US)

(73) Assignee: MyChic Systems Ltd., Haifa (IL)

(21) Appl. No.: 13/611,206

(22) Filed: Sep. 12, 2012

Related U.S. Application Data
(60) Provisional application No. 61/533,280, filed on Sep. 12, 2011.

(51) Int. Cl. G09G 5/00

(52) U.S. Cl. 345/633

(57) ABSTRACT

A computerized method for superposing an image of an object onto an image of a scene, including obtaining a 2.5D representation of the object, obtaining the image of the scene, obtaining a location in the image of the scene for superposing the image of the object, producing the image of the object using the 2.5D representation of the object, superposing the image of the object onto the image of the scene, at the location. A method for online commerce via the Internet, including obtaining an image of an object for display, obtaining an image of a scene suitable for including the image of the object for display, and superposing the image of the object for display onto the image of the scene, wherein the image of the object for display is produced from a 2.5D representation of the object. Related apparatus and methods are also described.

### RELATED APPLICATION

This application claims the benefit of priority under 35 USC 119(e) of U.S. Provisional Patent Application No. 61/533,280 filed Sep. 12, 2011, the contents of which are incorporated herein by reference in their entirety.

### FIELD AND BACKGROUND OF THE INVENTION

The present invention, in some embodiments thereof, relates to methods and systems for producing augmented reality and, more particularly, but not exclusively, to methods and systems of using augmented reality for various applications.

Augmented Reality (AR) technologies enable combining (Augmenting) synthetic visual elements with images and movies; the images and movies can be real-time live scenes or pre-captured. The synthetic visual elements can be images, graphics, animation, text, and combination of the above.

Based on an ability to analyze camera images and combine visual elements, a number of Augmented Reality applications have been developed. For instance, in a typical system, a user points his camera to an interesting scene, while an Augmented Reality application composes a scene including a visual element or elements, preferably in a way that seems natural as possible considering the scene, the visual elements and the application. Examples include: composing a name of a picture over pictures in a museum; composing direction arrows on a road while driving a car; and adding a dancing puppet on a table.

During recent years various attempts have been made to demonstrate use of Augmented Reality for online retailing. For example, Ray-Ban virtual mirror allows a user, using a PC, to select various sun-glasses and see the sun-glasses composed over a picture of his face, uploaded by the user or over a live video captured by a camera. Similarly, Holition supports Augmented Reality solutions for the jewelry industry, and Zugara provides Augmented Reality solutions for the fashion industry.

The disclosures of all references mentioned above and throughout the present specification, as well as the disclosures of all references mentioned in those references, are hereby incorporated herein by reference.

### SUMMARY OF THE INVENTION

Some embodiments of the present invention provides a method to overcome the modeling challenges of objects for Augmented Reality applications and provides a system for implementing Augmented Reality platform for applications such as online retails.

The term “augmenting”, in its various grammatical forms, is used throughout the present specification and claims to means superposing one or more objects over an image and/or a video scene.

Augmenting objects over a real video scene requires adjusting the objects according to their target location in the video scene and the dynamic behavior of both objects in the video scene and the augmented items themselves. Fully rigid items such as a ring augmented over a finger may optionally be adjusted using a rigid transformation (scaling, rotation, shift, perspective), along with finger-ring occlusion considerations. Semi-rigid items may preferably also allow adjustments by sections, such as in sunglasses—front and arms. Non-rigid items such as clothes may preferably support full dynamic flexibility, so that photo-realistic composition may be achieved. Augmenting semi-rigid and non-rigid objects over a dynamic video scene may use a capability if animating the objects.

AR systems for online retailing may require item modeling, and if the systems offer a video-based solution, may also require item (object) animation. Item modeling is presently typically performed by using a high quality 3D model or by composing a 3D-like (also called 2.5D) model from multiple images. 3D or 2.5D models animating capabilities should preferably match a target environment and type of augmented items. 3D modeling tools can enable object animation, however this may requires using a 3D model rather than images of the object, which may limit usage to items which already have such models or to applications which can justify an extra expense and a time-lag in preparing the model. Composing 2.5 D models of objects using 2D images is presently slow and the resulting model is presently difficult to animate accurately.

According to an aspect of some embodiments of the present invention there are provided Augmented Reality (AR) methods and systems with a boosted efficiency that allow quick modeling through use of 2.5D modeling, optionally based on capturing object images into photo-realistic vectors which include images taken from different angles, optionally using templates for locating and isolating desired objects in each image, and finding corresponding elements of same objects between images, optionally using a template, and using the corresponding elements, mapped in accordance with the templates, to stitch the objects in the images into a 3D-like, 2.5D model, and using the model to quickly adjust the objects over real images while using templates and locators to find the desired location for augmentation, and also trackers to retain it over a video scene image sequence if the scene is Video rather than a static image, and render the adjusted 3D-like model into a 2D image and augment it by compositing it onto the target location of the objects at the target location environment. According to further aspect of some embodiments of the present invention animating the objects for augmenting them onto a video scene is provided by animating their photo-realistic vectors representation, to match the beneath images of the Video scene image sequence. According to a further aspect of some embodiments of the present invention a human operator optionally assist the process of isolating the objects for the modeling process. According to a further aspect of some embodiments of the present invention the user optionally assist the process of locating the target location for the composed object by using adjustments made by him.

According to an aspect of some embodiments of the present invention there is provided a method and system for automatically identifying and overcoming occlusion of the target location for the augmentation by similar or different objects, by usage of locators and trackers that with the help of templates locate and track occluding objects, for the purpose of the Augmented Reality augmentation of the desired object.

According to an aspect some embodiments of the present invention there is provided an apparatus that is capable to be configured by the relevant case to use various locating and tracking blocks in the right sequence in conjunction with an intelligent result integration module in order to perform automatic integrated locating and tracking of target locations and occluding objects without a-priori knowing the exact scene and occlusions, for the purpose of augmenting a desired object over an exact target location.

According to an aspect of some embodiments of the present invention there is provided a method and system for identifying with the help of templates areas belonging to the original image or video but that are occluded by an object that should not appear on the Augmented Reality composition, and replacing them for the purpose of the Augmented Reality augmentation by using templates, locators using them and trackers to create a mask, and painting the relevant sections of the mask with a pattern based on using intelligent hints to select and use neighboring areas that are not occluded, such as visually eliminating a large watch located on a hand, by repainting from vicinity, in order to augment a smaller watch.

According to an aspect of some embodiments of the invention there is provided a method and system for modifying the background image or background video of the main object on which the augmented objects are augmented-on, by locating and tracking the main object and creating a mask of it, and replacing its background completely or sections of it by using background images that are matched over the scene using locators and trackers, or/and by using image processing techniques changing its lighting and/or other parameters, in order to imitate target usage environments and locations; an example would be to examine new sun glasses while the user is composed over sceneries in Paris.

According to an aspect of some embodiments of the invention there is provided a method and system for real-time linking along the augmenting process, between the continues scaling options of the 2.5D objects models to the true discreet offered sizes of real objects using a locator to locates a reference object or a measurement element and an analyzer to accordingly extrapolate relevant sizes, such as given finite sizes of eyeglasses that should be composed over images of faces matching as possible physical sizes.

According to an aspect of some embodiments of the present invention there is provided a method and system for automated assignment of augmented objects that are relevant for the image or video they are intended to be augmented on by analyzing the user's attributes at the target environment picture and automatically suggesting him objects to augment-on that the system think that are best-fit based on the desired object type he would like to augment, optionally even without asking him to select desired objects types he would like to augment. According to further aspect of some embodiments of the present invention, the more relevant specific objects are matched, for example not just analyzing a person face attributes such as color and aspect ratio and bringing sun glasses and earrings, but also proposing him to try only those that are considered as a better fit, such as proposing a silver colored eyeglass frame to a bald person, or colorful frame to a young man. According to a further aspect the consideration for proposing augmented objects are optionally driven by external aspects such as statistical preferences gathered by the retailer or exemplary preference such as a celebrity preferred sun glasses model. According to a further additional aspect of the current invention, the user can upload to the Augmented Reality system a reference image, such as an image of a celebrity or an advertisement, that contains items that the user wish to have similar or identical ones for himself, and asking the system that will use reference templates and models to find a similar item to that the celebrity is using or is shown by the advertisement, such as a special shirt or hat, and augment it over the user's image or clip a similar shirt and show it to him augmented on himself; a similarity ranking is optionally provided. According to additional aspect of the embodiment this is performed by using two phases—in the first phase the user ‘show’ the system the reference image and the system analyze it using locators and templates and optionally with the help of the user pointing at the desired object, to find similar ones, while the second phase is the augmentation, optionally based on suggestions made using the hints found by the first phase analysis for selecting a matching object model which is then presented to the user, optionally such that if more than a single relevant object type is discovered the user is optionally asked to select a desired object type and then the augmentation process proceeds.

According to an aspect of some embodiments of the present invention an automated agent using an analyzer which uses a locator and optionally templates to produce hints, and optionally an agent that uses the hints along with meta data related to potential objects proposed to the user to promote usage or selling of items using Augmented Reality system is provided. Such agent can let the user know an opinion on the fitting of the specific object to his needs and the overall look of it, propose alternatives, optionally using Text to Speech along with a speaker or just Text or Images such as Icons shown over the image or other means or any combination of them.

According to an aspect of some embodiments of the present invention there is provided method and system for distributed Augmented Reality applications using a remote camera that captures items that are desired to be augmented over an image or live video, such as a situation in which a person A sees eye glasses or a watch in the store, and using a video call from his mobile phone, via a server, allows person B to see the object composed over face or hand, accordingly. According to some aspects of some embodiments of the present invention various cases are supported such as using a remote platform to captures the desired objet image and analyze to identify it with the help of relevant templates and send the result to a website having an object matching application that finds the model of the exact object or a similar one and instruct the Augmented Reality Application of the end user to use it as the model of selected object and augment it or optionally showing him a family of selected objects similar to the one captured remotely and asking him to select an object for the augmentation, or similar to the above cases but wherein the analysis is done at the end user platform, or even similarly to the above but without an analysis success but with using the extracted object for the augmentation either directly just with adjustments to the target location or even with creating a 2.5D model using artificial added relevant information if the object type is known or identified, or similar to all above cases but in which just the images captured by the remote platform is delivered to the end user platform that carries on remaining tasks, if needed with the help website having an object matching application that finds the model of the exact object or a similar one; According to additional aspect of some embodiments of the present invention optionally the communication between the two user's platforms will optionally done using a Video Call; the Video call will optionally routed through network resources such as Operator's Video calls servers, or alternatively through additional servers of the Augmented Reality System but not shown in the diagrams.

According to an aspect of some embodiments of the present invention there is provided a computerized method for superposing an image of an object onto an image of a scene, including obtaining a 2.5D representation of the object, obtaining the image of the scene, obtaining a location in the image of the scene for superposing the image of the object, producing the image of the object, suitable for superposing at the location, using the 2.5D representation of the object, superposing the image of the object onto the image of the scene, at the location.

According to some embodiments of the invention, the obtaining the 2.5D representation of the object includes capturing a plurality of photo-realistic images of the object taken from different angles to the object, and producing the 2.5D representation of the object based on the plurality of images.

According to some embodiments of the invention, the obtaining a 2.5D representation of the object further includes extracting from at least some of the plurality of photo-realistic images of the object only portions of the plurality of photo-realistic images which include the object.

According to some embodiments of the invention, the extracting includes a human operator assisting the extracting.

According to some embodiments of the invention, the obtaining a location in the image of the scene for superposing the image of the object includes using templates characteristic of the location.

According to some embodiments of the invention, the obtaining the location in the image of the scene for superposing the image of the object includes a human operator assisting obtaining the location.

According to some embodiments of the invention, the image of the scene is produced from a 2.5D representation of the scene.

According to some embodiments of the invention, the image of the scene is included in a video.

According to some embodiments of the invention, the image of the scene is produced by a camera at a user location, and wherein the obtaining the image of the scene includes the user uploading the image of the scene.

According to some embodiments of the invention, the obtaining a location in the image of the scene for superposing the image of the object includes tracking the location in a plurality of video frames in the video sequence, and the superposing includes superposing a plurality of images of the object onto the plurality of video frames in the video sequence at the location in at least some of the plurality of video frames.

According to some embodiments of the invention, the superposing the image of the object includes producing an animation of a plurality of images of the object and superposing the animation onto the plurality of video frames.

According to some embodiments of the invention, the obtaining a 2.5D representation of the object further includes stitching the portions into the 2.5D representation of the object, wherein the stitching the portions includes detecting corresponding locations in the portions of the plurality of photo-realistic images of the object.

According to some embodiments of the invention, the detecting corresponding locations in the portions of the plurality of photo-realistic images of the object includes using templates characteristic of the corresponding locations.

According to some embodiments of the invention, the obtaining a 2.5D representation of the object includes a user using a camera to capture a plurality of images of the object taken from different directions to the object, the user uploading the images to a computer, and the computer producing the 2.5D representation of the object based on the plurality of images.

According to some embodiments of the invention, the obtaining a 2.5D representation of the object includes a user using a device including a camera and a computing unit to capture a plurality of images of the object taken from different directions to the object, produce the 2.5D representation of the object based on the plurality of images, and the user uploading the 2.5D representation to a computer.

According to some embodiments of the invention, the obtaining a location in the image of the scene includes a user indicating at least one location in the image of the scene based, at least in part, on instructions provided by a user interface.

According to some embodiments of the invention, the instructions provided by the user interface are provided by a mobile computing device local to the user.

According to some embodiments of the invention, the instructions provided by the user interface are provided by a remote computer sending the instructions to a computing device local to the user.

According to some embodiments of the invention, the obtaining a location in the image of the scene includes automatically identifying occlusion of at least a portion of the location, and overcoming the occlusion using templates characteristic of the location.

According to some embodiments of the invention, the obtaining a location in the image of the scene includes automatically identifying occlusion of at least a portion of the location, and overcoming the occlusion using templates characteristic of the occlusion.

According to some embodiments of the invention, the location in the image of the scene is a location of an object in the image of the scene similar to the object the image of which is to be superposed.

According to some embodiments of the invention, the image of the object which is to be superposed does not cover all of the similar object in the image of the scene then portions which are not covered are painted by merging to neighboring areas in the image of the scene.

According to some embodiments of the invention, the merging includes continuing one or more image features from the neighboring areas leading up to the image of the superposed object, the image features selected from a group consisting of a gradient, a pattern, and image noise.

According to an aspect of some embodiments of the present invention there is provided a computer system for superposing an image of an object onto an image of a scene, including a first module for obtaining at least one 2.5D representation of the object, a second module for obtaining the image of the scene, a third module for producing the image of the object from the 2.5D representation of the object, a fourth module for superposing the image of the object onto the image of the scene.

According to some embodiments of the invention, further including a module for producing a plurality of 2.5D representations of the object from a plurality of images of the object.

According to some embodiments of the invention, further including a module for storing a 2.5D representation of the object.

According to some embodiments of the invention, the first module for obtaining the 2.5D representation of the object is adapted to receive the 2.5D representation of the object via communication with an additional computing platform.

According to some embodiments of the invention, the additional computing platform includes a smartphone including a digital camera.

According to some embodiments of the invention, the second module for obtaining the image of the scene is adapted to receive the image of the scene via communication with an additional computing platform.

According to an aspect of some embodiments of the present invention there is provided a method for online commerce via the Internet, including obtaining an image of an object for display, obtaining an image of a scene suitable for including the image of the object for display, and superposing the image of the object for display onto the image of the scene, wherein the image of the object for display is produced from a 2.5D representation of the object.

According to some embodiments of the invention, obtaining the image of the object for display includes selecting the image of the object for display from a catalog of images of objects.

According to some embodiments of the invention, obtaining the image of the scene includes a user uploading the image of the scene.

According to some embodiments of the invention, the object is a wristwatch and the scene includes a wrist. According to some embodiments of the invention, the object includes eyeglasses and the scene includes eyes.

According to some embodiments of the invention, the obtaining the image of an object for display includes analyzing properties of an object in the image of the scene, and presenting a user with a display of one or more images of suggested objects based, at least in part, on the analysis.

According to some embodiments of the invention, further including extracting an image of a person from the image of the scene, superposing the image of the object for sale and the image of the person onto a second, different image of a scene.

According to an aspect of some embodiments of the present invention there is provided a method for online commerce including a user selecting an object for sale from a computerized catalog of objects, a computer providing an image of the object, a user uploading a video of a scene suitable for including the image of the object, and superposing the image of the object onto the image of the scene, wherein the image of the object is produced from a 2.5D representation of the object.

According to an aspect of some embodiments of the present invention there is provided a method of producing a catalog of 2.5D representations of objects including obtaining a plurality of photo-realistic images of the objects taken from different angles to the objects, producing the 2.5D representations of the objects based on the plurality of images, and storing the 2.5D representations of the objects as a catalog.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a simplified block diagram illustration of an Augmented Reality (AR) system according to an example embodiment of the invention;

FIG. 1B is a simplified flow chart illustration of an Augmented Reality (AR) system according to an example embodiment of the invention;

FIG. 1C is a simplified block diagram illustration of an Augmented Reality (AR) system according to an example embodiment of the invention;

FIG. 2A is a simplified block diagram illustration of an AR Application Platform according to an example embodiment of the invention;

FIG. 2B is a simplified flow chart illustration summarizing flow of the AR Application Platform illustrated in FIG. 2A;

FIG. 3 is a simplified block diagram illustration of an AR User Platform according to an example embodiment of the invention;

FIG. 4 is another simplified block diagram illustration of an AR User Platform according to an example embodiment of the invention;

FIG. 5 is a simplified block diagram illustration of an AR User Platform according to an example embodiment of the invention;

FIG. 6 is a simplified flow chart illustration of locating a target and tracking the target, used in the example embodiment of FIG. 5;

FIG. 7 is a simplified block diagram illustration of an AR User Platform according to an example embodiment of the invention;

FIGS. 8A-8D are simplified illustrations of an example of augmenting a large watch having a thin strap over a smaller watch having a wider strap, according to an example embodiment of the invention;

FIG. 9 is a simplified block diagram illustration of an AR User Platform according to an example embodiment of the invention;

FIG. 10 is a simplified block diagram illustration of an AR User Platform according to an example embodiment of the invention;

FIG. 11 is a simplified block diagram illustration of an AR system according to an example embodiment of the invention; and

FIG. 12 is a simplified block diagram illustration of a system for distributed Augmented Reality applications according to an example embodiment of the invention.

### DESCRIPTION OF EMBODIMENTS OF THE INVENTION

The present invention, in some embodiments thereof, relates to methods and systems for producing augmented reality and, more particularly, but not exclusively, to methods and systems of using augmented reality for various applications.

### Overview:

An example use for an embodiment of the invention will now be described, in order to demonstrate at least one aspect.

A computer user navigates to a web page used for selling some objects. The user selects an object from a catalog. The web page includes a video of the user, optionally obtained in real time via a camera at the user's location. An embodiment of the invention superposes, or augments, the selected object onto the user's image in the video. Optionally, the object is photo-realistic, tracks the user's movements, changing attitude and/or size so as to fit the user's movements relative to the camera.

One use for such systems involves producing the model of the object.

Some embodiments of the invention include a method for producing a 2.5D model, rather than a full 3D model of an object, in order to make the producing simpler, faster, and capable of being performed by computers using less computing power than required for the full 3D model.

The term “2.5D model” of an object, in its various grammatical forms, is used throughout the present specification and claims means a collection of photo-realistic images of the objects, optionally taken from several different directions and/or magnifications, along with data about the object and/or about properties of the object images, such as the direction/magnification.

Some embodiments of the invention include using a smartphone/tablet/consumer camera for capturing images of the object and producing the 2.5D model.

Some embodiments of the invention include using a smartphone/tablet/consumer camera for capturing images of the object and sending the images to a computer server for producing the 2.5D model.

An aspect of some embodiments involves the degree of realism which the image of the superposed object presents to a viewer.

Some embodiments of the invention include using captured images of the object for superposing on a scene, as the images potentially present a more photo-realistic scene than an image of a model not using captured images.

Some embodiments of the invention include storing 2.5D models, rather than full 3D models, of an object, to be used in superposing an image of the object in a scene.

Some embodiments of the invention include identifying a location where an image of an object is to be superposed in a scene.

For example, when the object is a pair of glasses, the image of the object us typically superposed in use, that is, on a face in the scene, with the lenses superposed on eyes, optionally including some surrounding area, optionally frame handles over the ears. Another example may also involve glasses, rakishly placed back on the forehead, with the lenses superposed on the forehead or hair. Yet another example may involve the glasses in a user's shirt pocket, partly showing. Yet another example may involve a watch on a user's wrist. Yet another example may involve jewelry placed on a user's ear, neck, hair, and such locations where jewelry is placed. Yet another example may involve viewing a ring or other such object used in piercing, superposed at the piercing location, painlessly enabling a potential user to evaluate an appearance which the piercing will provide before undergoing the piercing.

In some embodiments, the location in a scene is determined automatically. For example, locating eyes or ears in a face may be done automatically. For example, locating a wrist may be done automatically.

In some embodiments, the location in the scene is determined interactively by a user. The user optionally received instructions from an embodiment of the invention how to present a face, arm, or other part of the body or clothing in order to provide a scene in which a computer can automatically locate the location.

In some embodiments, the user views the scene in which the object is to be superposed, and is instructed to interactively locate a cursor at one or more locations, which serve as key locations which a computer uses to calculate how to superpose the image of the object. For example, a user may be requested to place a cursor at one eye pupil, mark the pupil, and optionally place the cursor at a second pupil, and mark the second pupil.

In some embodiments, the user views an image of the object which is to be superposed, and is instructed to interactively locate a cursor at one or more locations, which serve as key locations which a computer uses to calculate how to superpose the image of the object. For example, the image of the object may be an image of a watch which was photographed and optionally uploaded to a computer system. The user may optionally be asked to place a cursor at several locations on a watch bezel and/or a watch face circumference, and or watch strap, optionally aiding the computer system to separate the image of the watch from a scene background, in order to use the separated image for superposition of the watch in other scenes.

In some embodiments, the image of the superposed object is used to replace an object in a scene. For example, replacing an image of a wristwatch in a scene with a superposed image of another watch. If the superposed image of the object is smaller than the image of the object already in the scene, a portion of the scene spanning a gap between the larger object in the scene and the smaller object which is to be superposed is preferably treated so as to appear as a natural part of the scene. In some embodiments of the invention image portions are produced to span the gap.

### Introduction:

According to some embodiments of the present invention, there is provided a method to overcome modeling challenges of objects for Augmented Reality applications and provide a system for implementing an Augmented Reality platform for applications such as online retail.

An example embodiment of such a system optionally includes one or more of: storage modules, for optionally storing a library of objects that can optionally be augmented over a camera image or a video clip; modules that convert stored images of objects, or live images of objects into a photorealistic vector-based representation; and an augmenting composer which optionally augments the vector-based representation of objects onto a subject of interest displayed in images or video clips. Additionally or alternatively, the storage modules optionally contain objects that were pre-processed and converted to vector representation.

The above-mentioned vector-based representation optionally uses the Synthesized Texture technology defined by above-mentioned ISO MPEG-4 part 19 ISO/IEC 14496-19, originally known as VIM and developed by Vimatix Inc. The technology is explained in various public-available documents which may be found on the World Wide Web and/or on the Vimatix web site. VIM technology provides methods for capturing images of objects into a photo-realistic based representation, and animating the images by using skeletonized images. The resulted animation has a photo-realistic natural quality as well.

In some embodiments, a 3D representation of the object is imitated by using multiple images of the objects, each taken from a different angle. Neighboring images are optionally taken so as to share areas of the scene, and optionally stitched to create a 3D-like representation also termed a 2.5D representation of an object of interest. 2.5D is a common term used to describe 3D representation based on 2D images. In some embodiments object background in the images is optionally removed in order to have a ‘clean’ object which can be superposed over a target scene without obscuring unnecessary areas of the scene. Object background removal is optionally performed using common graphics tools as Adobe Photoshop™ or other means such as VIM tools which use vector analysis for a quick cut of objects based on their edges. Stitching neighboring images is optionally done either manually, using computer graphics tools, or automated by finding corresponding elements in various images. In some embodiments, VIM vectors are optionally used for stitching, resulting in rapid and efficient stitching of neighboring images into a 2.5D representation of an object.

The 2.5D object is matched to a target environment. For rigid objects, affine transformations are sufficient for matching; image stitching preferably provides depth or other similar relevant structural data. The VIM technology allows providing depth information to each photorealistic vector, and to stitch images in the photorealistic vector using a flexible skeleton. The stitching optionally crosses borders between neighboring images, resulting in a photo-realistic animation-ready model. Having depth information also enables hiding elements that should be hidden by a target environment. For example, a hand may have a depth figure of 5, watch elements may have depth figures from 1 to 10, (optionally continuous), and only the watch elements having a depth smaller than 5 may be shown. In an example scenario a user is looking at the front side of his wrist, the watch receives a depth figure of one, and the watch strap has figures of 1 to 10, while strap elements having a depth figure of 5-10 are not be shown.

Augmenting an object to a scene can involve superposing the item over a background which is an image of a similar, corresponding object or objects in a target environment. The superposing may use depth information of the superposed item as described above. The superposed object is preferably superposed so as to completely replace the image of the object in the target environment. Locating the superposed image optionally includes dimension scaling, orientation transformations, proportional considerations, and optionally non-linear distortion. Therefore there is a need to locate the accurate boundaries in which the superposed object will resides and adjusted too, the needed orientation, and distortion, if applicable. This is done by adjusting a frame with the shape of a known objet that can be accurately linked to the superposed object, onto the target environment image, using special points that are identifies by image processing and analysis engines. An example would be matching sunglasses by using an ellipse to trace a shape of a head in an image, while the ellipse is adjusted by the head edges, and inside the ellipse the eyes pupils are traced and used as reference locking points to the sunglasses. Using additional discovered points such as the nose, 3D transformations are optionally applied, and in conjunction with the eyes tracking, the sunglasses are properly scaled. Optionally it is possible to use detection of the ears and add and adjust the sunglasses handles. In such case the handles and the Sunglasses front superpose together three parts of the object, and be linked using a three-part skeleton.

Superposing objects over video scenes uses the same principle as above, while the special identified points are tracked through the image sequence of the scene. It is possible to track multiple points and use only those that are considered to be tracked with high probability. Point tracking optionally uses simple correlation, or more advanced methods that consider geometric relations and their change over time throughout the image sequence of the clip.

The above description, clearly indicate that using the VIM photorealistic vector-based technology results in quick processes of isolating objects from images, and composing a 2.5 model of them out of neighboring images that contain them, mapping them over the target environment, and animating them as needed.

The library of objects belongs optionally to a single or multiple applications, while the objects themselves are optionally uploaded remotely to the storage modules by the applications providers or its content providers; optionally they are not the same. For example, an application provider develops an Augmented Reality application for selling Jewelries, while Jewelries shops upload the images of their merchandise thorough the web. Using known methods the storage modules are typically implemented using a database, and such database optionally supports multiple storage instances representing various applications and content providers, while the content itself is optionally uploaded through various means such as FTP, SFTP (Secured FTP), sent over emails, use dedicated peer applications, etc.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Augmented Reality System:

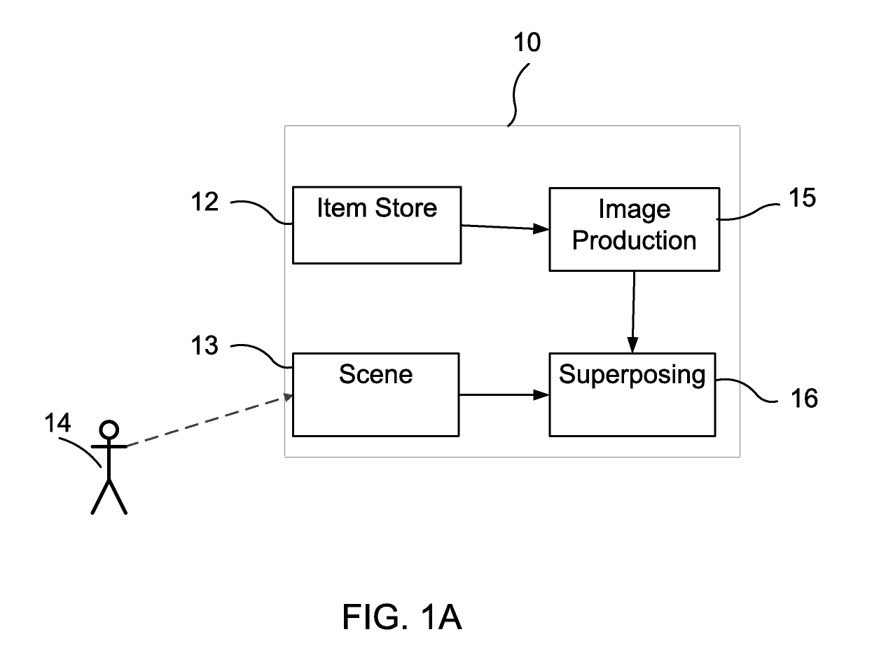

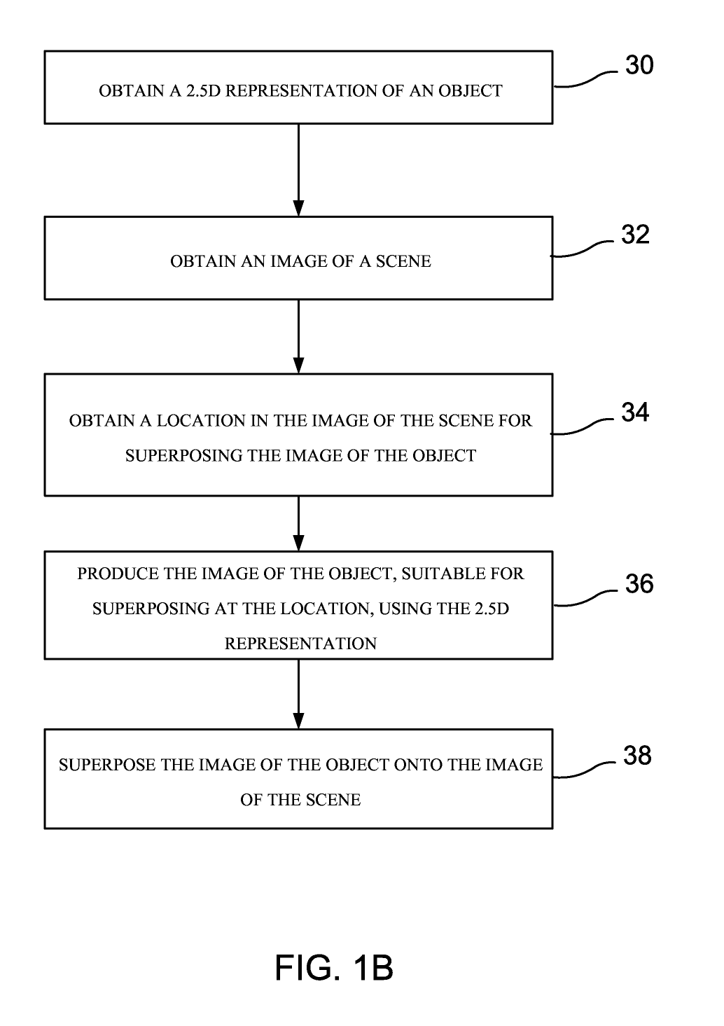

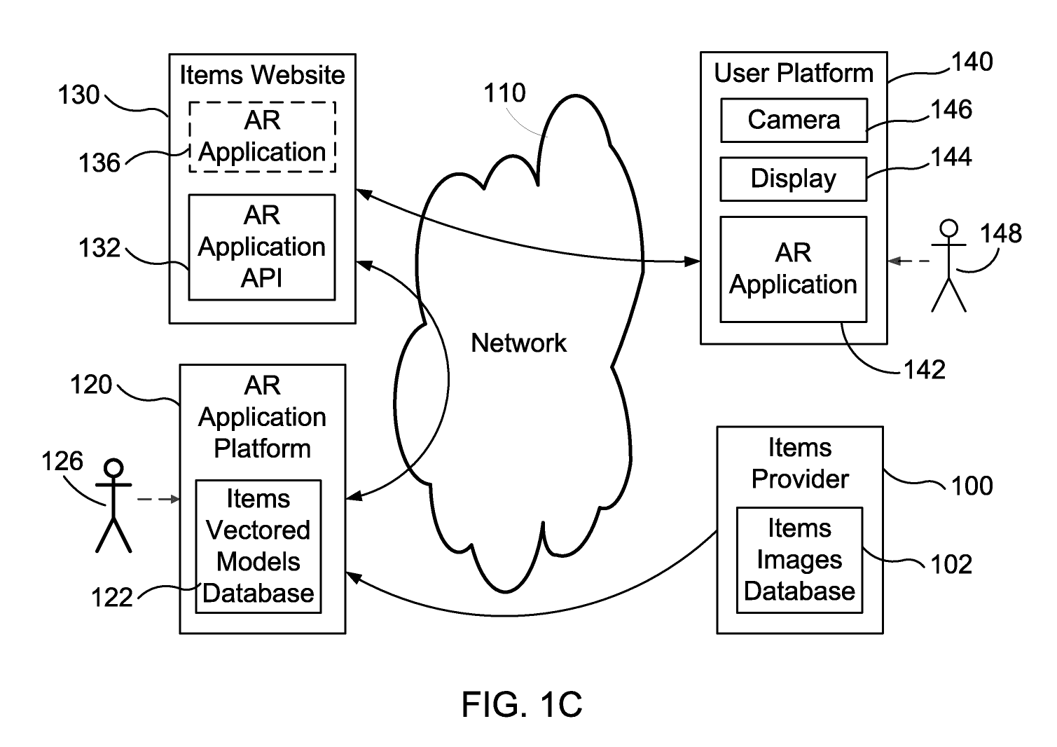

Reference is now made to FIG. 1A, which is a simplified block diagram illustration of an Augmented Reality (AR) system 10 according to an example embodiment of the invention.

FIG. 1A depicts a simplified AR system 10 which includes a first module 12 for storing a plurality of 2.5D representations of the object, a second module 13 for obtaining a scene, or simply a second image, a third module 15 for producing an image of an object from the 2.5D representation of the object, and a fourth module 16 for superposing the first image of the object onto the second image.

In some embodiments, a user 14 uploads the scene to the AR system 10.

Reference is now made to FIG. 1B, which is a simplified flow chart illustration of an Augmented Reality (AR) system according to an example embodiment of the invention.

The method of FIG. 1B is an example embodiment of a method for a computer to superpose an image of an object onto an image of a scene, which includes:

obtaining a 2.5D representation of the object (30);

obtaining an image of a scene (32);

obtaining a location in the image of the scene for superposing the image of the object (34);

producing the image of the object, suitable for superposing at the location, using the 2.5D representation of the object (36); and

superposing the image of the object onto the image of the scene at the location (38).

Reference is now made to FIG. 1C, which is a simplified block diagram illustration of an Augmented Reality (AR) system according to an example embodiment of the invention. FIG. 1C depicts schematic illustration of an Augmented Reality system with boosted efficiency, which enables potentially rapid modeling of objects and quickly adjusting them over real images. An Items Provider 100 provides objects to be presented to end users of the Augmented Reality platforms. Throughout this embodiment the terms “Items:” and “Objects” will be used to describe the Objects that optionally need be augmented using the Augmented Reality platform. Items Images Database 102 contain a library of images of these objects; each object typically have few images each typically taken from a different angle, altogether or some of them allowing composing a 2.5D representation of the item; at least one of the images or the 2.5D representation will optionally be used to produce a representative image such as a thumbnail of the object for showing the end user and allowing to select the certain object. However, it might be that a single image is sufficient and no composing is needed, such as in some Tattoo images. The items images are uploaded through the Network 110 to the Augmented Reality Application Platform 120, wherein they are converted to vectored models, and stored in the objects models library Items Vectored Models Database 122, along with templates that are built and assigned per family of objects. The items images alternatively will be downloaded from the Items Provider Database by the Augmented Reality Application Platform 120. The Augmented Reality Application Platform 120 optionally supports multiple Item Providers 100. The Items Images supported by the Items Providers has also suitable metadata that allows preserving the descriptions and references between different images of the same object, between families of objects, and between images supported by different Item Providers. Some elements of the Metadata are optionally alternatively be assigned by the Augmented Reality Application Platform 120 itself, such as assigning the ID of the Items Providers based on his URL found while communicating him.

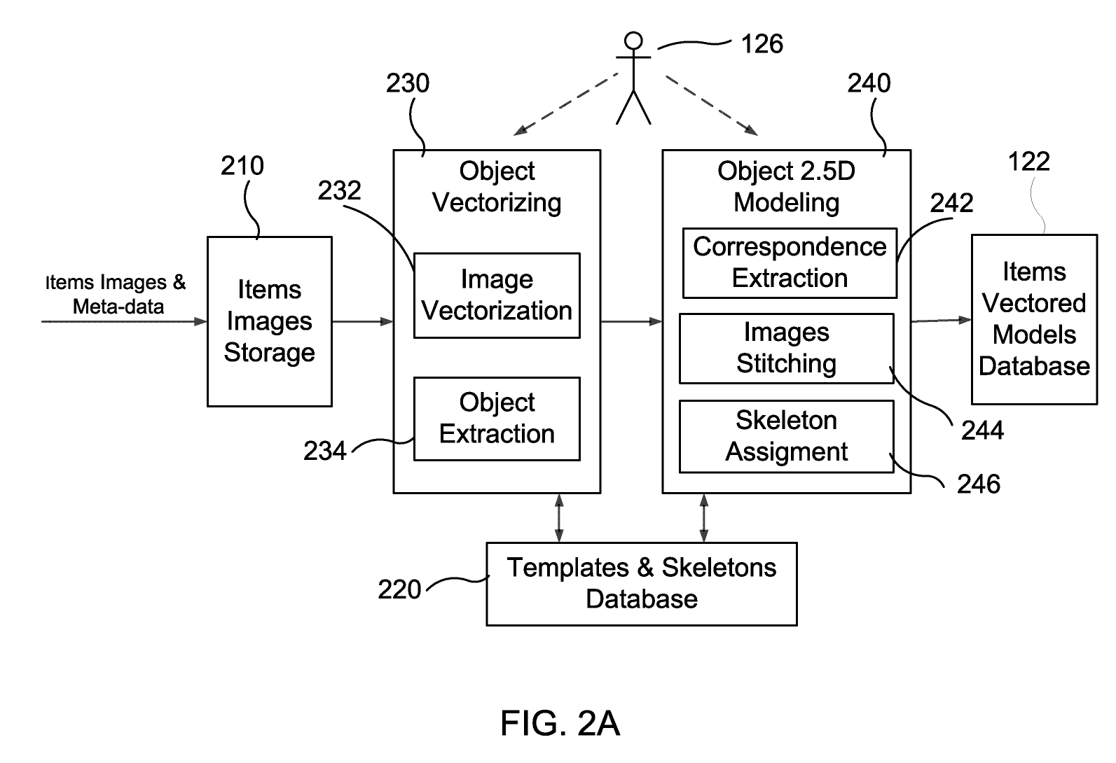

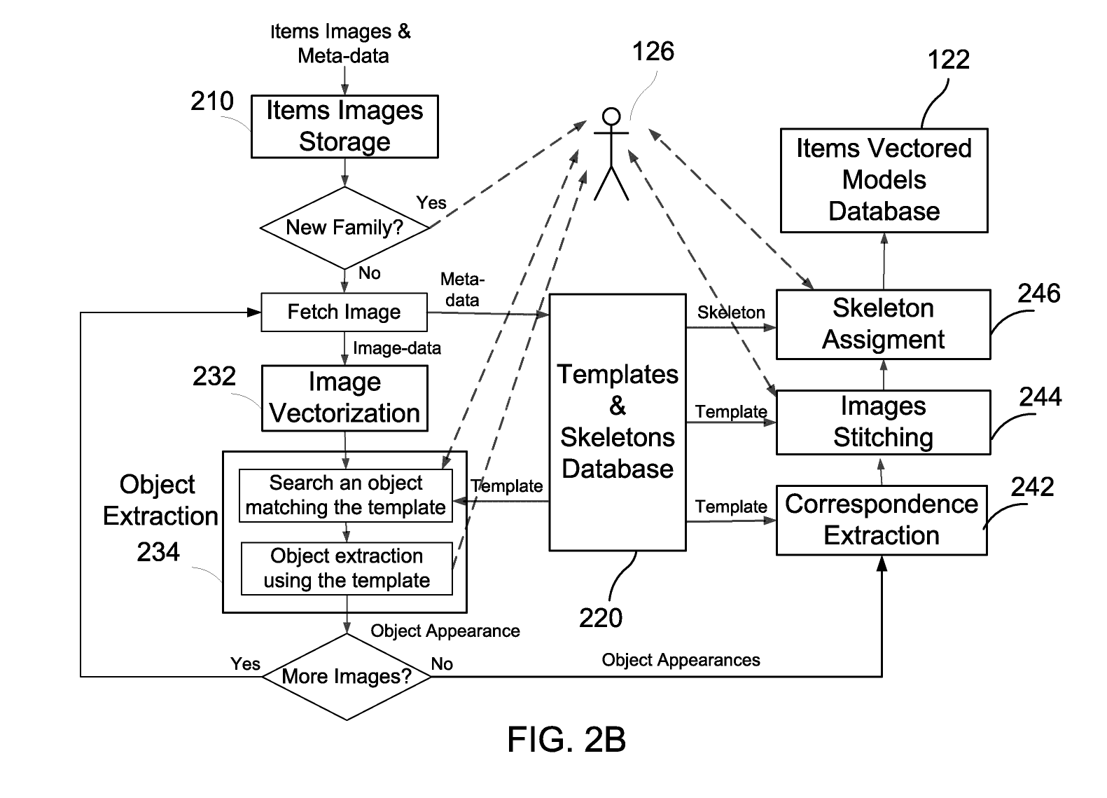

The Augmented Reality Application Platform 120 vectorizes the item images, isolates the objects and builds 2.5D models out of them, as will be further explained in reference to FIG. 2A of this embodiment. Optionally, operator 126 helps in the process of converting the items images into an items vectored form, as will further explained in reference to FIG. 2A. Each object family optionally has templates that assist in isolating the objects and building their 2.5D model as well as augmenting them over the target destination image, as also explained in accordance with some embodiments of the invention. The templates are prepared or assigned by the help of Operator 126.

Items Website 130 on one hand provides the Application front end to the User 148 that uses User Platform 140 for interacting with the Augmented Reality Application for selecting the desired items from the relevant family of objects in the library by using their representative images, per the items offered by the specific Items Provider, and viewing them, and from the other hand using Augmented Reality Application API 132 to interact with the Augmented Reality Application Platform 120 for bringing the items that are selected by the User 148.

User Platform is a device having computing means, a display 144, interactions means attached to it or built-in, and a camera 146 wither built-in or attached. Various examples are a Desktop PC with an attached keyboard, mouse and a camera, a Notebook PC with an integrated Keyboard, Touchpad and a Camera, or a Mobile Phone. User Platform 140 runs the Augmented Reality application 142; Augmented Reality Application 142 is preinstalled, embedded, or downloaded from an external source such as a download server or applications store. Optionally it can be downloaded from Items Website that maintains it inside as Augmented Reality Application 136 or redirects User Platform 140 to download it from an external source. The Augmented Reality Application is optionally a PC stand-alone application, or an application using a framework such as Flesh, or an application that run in a browser environment such as Active-X running in Web-sites under Internet Explorer, or a combination of the above such as a Flash module or a Silverlight application running in the browser. In the context of Items Website 130, and a PC-based User Platform 140, there is a preference that Augmented Reality Application 142 runs in a Web Browser. An example is Active-X running in Microsoft Corporation's Internet Explorer™, and downloaded from the Items Website itself. In case of a Mobile Phone acting as User Platform 140, a Web Browser will optionally be used, mainly in Smart Phones, while a stand-alone application will optionally be used too, communicating with Items Website using Web Services or other available techniques.

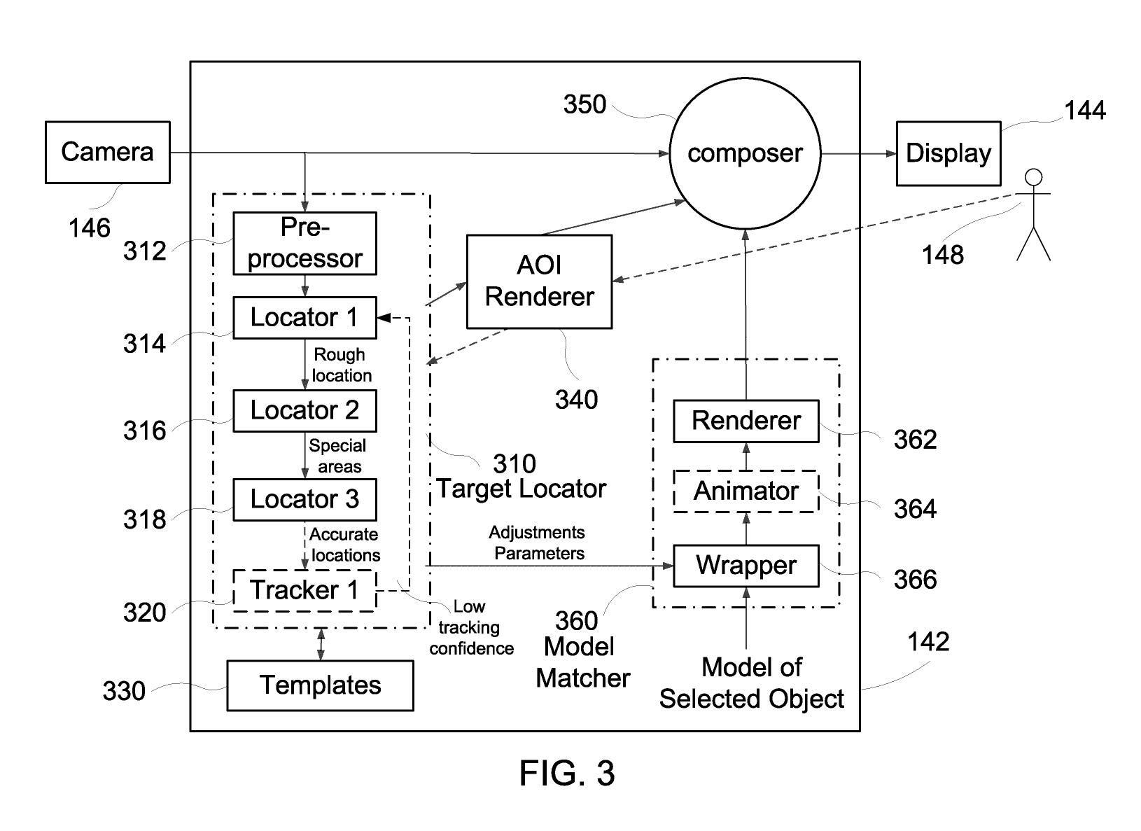

User Platform 140 Camera 146 is used to picture the target location of the Item that will need to be augmented, while the item model itself is selected by interaction by user 148 using User Platform 140 interactions means and Display 144 with Items Website 130, which gets the models from Augmented Reality Application Platform 120. Examples for Items and Target Locations are Eyeglasses over a Face, a Watch over a Hand and a Hat over a Head. Items Website optionally cache or store the Items Models by itself, and they are optionally cached also or alternatively by User Platform 140. The selected Item Vectored Model is augmented by the Augmented Reality Application 142 over the Image pictured by Camera 146 and shown to the user 148 via Display 144. Camera 146 produces static images or video. FIG. 3 of this embodiment describes an Augmented Reality application based on either Static or Video Image. The augmentation process itself as describe in conjunction to various embodiments of the current invention, contains adjusting the object to its target location, superposing it onto the target image and animating it if it's a Video Image.

Network 110 is optionally the Internet or a local network or some combination of networks; it is understood that some of the blocks 100, 120, 130 and 140 optionally will communicate between them directly. For example, Augmented Reality Application Platform 120 optionally hosts also Items Website 130. In a further example, Items Website 130 optionally contains Augmented Reality Application Platform 120 serving only his relevant content.

### Augmented Reality Application Platform:

Reference is now made to FIG. 2A, which is a simplified block diagram illustration of an AR Application Platform according to an example embodiment of the invention. FIG. 2A depicts a schematic illustration of an Augmented Reality Application Platform, detailing Augmented Reality Application Platform which optionally serves as the FIG. 1C Augmented Reality Application Platform 120, which is capable of vectorizing the items images, isolating the objects and building 2.5D models out of them, according to some embodiments of the present invention. Items images that need to be vectorized are downloaded or uploaded onto Items Images Storage 210, sorted by means of Meta Data or alike or and using different addresses such as different URLs, by images of the same objects, optionally also per families of items, and if applicable also per Items Suppliers. Object Vectorizing module 230 optionally vectorizes the desired item in each relevant image by a two phase method: First, part or a whole image is vectorized into a photo-realistic vector representation by the Image Vectorization sub-module 234, and then the item itself is optionally extracted from its background by Object Extraction sub-module 234. In order to assist in the Object Vectorizing process, a Template from Templates & Skeletons Database 220 will optionally be used. Templates & Skeletons Database 220 contains templates of the shapes of objects that optionally need be extracted from images, and templates of such objects seen from different angles along with a connecting skeleton. The templates are typically given in a vector form, matching the format of the photo-realistic vectors as of the images vectorized by Image Vectorization sub-module 232. The skeleton is later used in the augmentation process to adjust the object 2.5D model and to animate it if applicable, as will be explained in reference to FIG. 3 in relation of some embodiments of the current invention. Templates & Skeletons Database 220 is populated per the objects families supported by the Augmented Reality Platform. For example, it might supports eyes-glasses templates and skeletons supporting at least some of the items providers that support sunglasses, and additionally or alternatively it might support rings templates supporting at least some of the items providers that support rings. In the context of sub-module Object Extraction 234, Templates & Skeletons Database 220 provides templates that assist in the object extraction process, as will be further described below. Operator 126 optionally assist in the Object vectorizing process, as will be further described below.

Prior the object vectorizing process, the metadata is evaluated looking for new objects that belong to new families. In case the evaluation of the metadata reveals that there are new frames that are belonging to at least one new family, Operator 126 is alerted and need to assign templates, and also skeletons if applicable, for the new families. He then reviews all the frames of objects that belong to each new family, and tries to assign one of the existing templates including their skeletons if applicable, to each of the new families. If he can't find a matching template for a certain family of frames, he needs to conduct a process of defining a new matching templates set and skeletons if applicable. The meta data evaluation is not shown by FIG. 2A.

The process of the object vectorizing process performed by the Object Vectorizing module 230, optionally if the evaluation shows the object belongs to a known family include:

An image is vectorized by sub-module 232 and is transferred to Object Extraction sub-module 234.

A template relevant to the desired object and if available also considering the angle the photo was taken from is traced and transferred from Templates & Skeletons Database 220 and transferred to Object Extraction sub-module 234.

Object Extraction 234 sub-module searches in the vectorized image for an object matching the template. The search is made by vectors adjusting and matching. The search result is optionally presented to Operator 126 that will refine it in case needed.

The desired object found by the above-described search is accurately extracted by Object Extraction sub-module 234, optionally using the Template used for the search, or a different template that is more accurate than the one used to find the object in the image. The extraction result, called also “Object Appearance”, is optionally presented to Operator 126 that will refine it in case needed.

The above actions may optionally be performed in a different order, or with a unifying or a splitting of some actions, and alternatively using a real image for the template and matching it with a real image of the object. Optionally some of the actions are skipped; for example, Operator 26 optionally manually draws a border of the object and extracts the object, for example by using a commercially available software like Adobe Photoshop™, or by using vector drawing tools that optionally use the same vector formats using by the Image Vectorization sub-block 232.

The object extracted by Object Vectorizing module 230 is transferred to Object 2.5 Modeling module 240. This is optionally done for all the object appearances extracted from the various images taken from various angles. The 2.5 Modeling module 240 creates a 2.5D model of the object, optionally by a three phase method: First neighboring object appearances are analyzed for finding a corresponding point between them. An optional example will be tracing the axis between an eyeglass frame front to its handle, on both a front-taken image and side-taken image; another example will be tracing the edge line between the top section of the eyeglass front image to an image taken at looking from 30 degrees from the top, so as to model the eyeglass frame thickness. Then, based on the correspondence found between the images, and if relevant to the object, its various appearances are stitched together; the last stage is assigning a skeleton to the stitched object. Templates & Skeletons Database 220 provides templates that assist in the object stitching and skeleton assignment processes, as will be further described below. Operator 126 optionally assist in the Object Modeling process, as will further described below.

The object modeling process performed by Object 2.5D Modeling module 240 includes:

The various object appearances are gathered at Correspondence Extraction sub-module 242 and neighboring areas in various appearances are analyzed for extracting corresponding points between them. This is based on the pre-knowledge of the various appearances, such as eyeglasses front image and side image. Based on this pre-knowledge, corresponding elements such as corresponding vectors are each searched and matched, per the candidate regions of each image. The correspondence matching result is optionally presented to Operator 126 that will refine it in case needed.

Templates & Skeletons Database 220 provides Image Stitching sub-block 244 a model of the object elements structure and relations, and the Image Stitching sub-block 244 maps the correspondence data of neighboring areas in various appearances, extracted by Correspondence Extraction sub-module 242, onto this model and stitches the various appearances of the object into an Object Model. The stitching result is optionally presented to Operator 126 that will refine it in case needed; Stitching neighboring images also is optionally done manually by Operator 126, using common graphics tools.

Templates & Skeletons Database 220 provides the relevant Skeleton to Skeleton Assignment sub-block 246 a model of the object elements structure and a connecting skeleton, and the Skeleton Assignment sub-block 246 maps the skeleton over the Object Model built by Image Stitching sub-block 244, and along with assigning depth information attached to the Skeleton and to the object images vectors, it creates the 2.5D Model of the object. The 2.5D model is optionally presented to Operator 126 that will refine it in case needed, typically by adjusting the Skeleton and its points of connections with the underlying images. Skeleton assignment or even drawing is optionally done manually by Operator 126.

The above actions may optionally be performed in a different order, or with a unifying or a splitting of some actions. Optionally some of the actions are skipped; for example, Operator 26 optionally manually stitches the images without a need for automated correspondence extraction. In another example Image stitching and Skeleton assignment are optionally performed within the same process, for example in a case that the stitching pints correspond to the skeleton connecting points. Multiple Skeletons will optionally be assigned to an object; Optionally some objects, typically solid objects without moving elements, do not need a skeleton, and some objects such as a Tattoo, optionally do not even need more than a single image and therefore images stitching might not relevant for them.

The resulted 2.5D vectored model of the object is transferred to Items Vectored Models Database 122. Items Database 122 contains a library of all items that are handled by the Augmented Reality Application Platform, arranged per families, items providers, etc.

As described in accordance with FIG. 1C, one or more of the object's images optionally serve to create representative image for end-user's view and optional selection of the object to be augmented. Such representative image is optionally vectored based or rendered based. Making them vectored-base typically reduces their size and save networks and storage resources. Treating representative images is not explicitly shown by FIG. 2A; however it is assumed that any of the approaches is optionally supported, and in either way the representative images are also stored at Items Vectored Models Database 122, even if they are not vectored. Some of the vectored images made through the Object Vectorizing process are optionally used as representative images, whether isolated or not. The meta-data describes, among other indications it provides, which images are used as representative image, whether it's a fully modeled image or just a vectorized image, or non-vectorized image. If it's a vectorized image, it is rendered later in the process, typically by the Augmented Reality Application 142 at User Platform 140, those enabling fast & efficient transport, especially if using the model itself for the purpose of making a representative image of the object.

Reference is now made to FIG. 2B, which is a simplified flow chart illustration summarizing flow of the AR Application Platform illustrated in FIG. 2A. FIG. 2B depicts a flow diagram summarizing the flow of the Augmented Reality Application Platform described by FIG. 2A. The description of the flow described by FIG. 2B is similar to the descriptions of FIG. 2A, including Object Vectorizing and Object Modeling sub-blocks and actions; Block numbering in FIG. 2B are similar to FIG. 2A, while FIG. 2B adds conditional actions (Yes/No), some sub-block detailing and flow-arrow names, all similar to the above description made in relation to FIG. 2A; As such, FIG. 2B should be self-explanatory to persons skilled in the art, based on FIG. 2A description and no detailed explanation for FIG. 2B is given here.

According to some embodiments of this invention the vector models and the object vectorizing and modeling processes optionally use Synthesized Texture technology defined by ISO MPEG-4 part 19 ISO/IEC 14496-19, originally known as VIM and developed by Vimatix Inc.

### Augmented Reality User Platform:

Reference is now made to FIG. 3, which is a simplified block diagram illustration of an AR User Platform according to an example embodiment of the invention. FIG. 3 depicts a schematic illustration of an Augmented Reality User Platform, detailing Augmented Reality User Platform that optionally serve as the User Platform 140 of FIG. 1C, which is capable of obtaining an image of the target environment that contains the target location for the augmented object, locating that target location at the image of the target environment, adjusting the 3D-like called also 2.5D model of the augmented object model per its target location for being matched to the target environment, rendering the adjusted 2.5D model into a 2D image, superposing the said 2D image of the said adjusted 2.5D model onto the target location of the objects at the target location environment, and displaying the said superposed image to the end user, according to some embodiments of the present invention. Not shown in this diagram in the context of block 140 of the Augmented Reality system as described in FIG. 1C according to some embodiments of the present invention, is the blocks and process of selecting the object to be augmented, as this is described elsewhere in this invention, such as in conjunction to FIG. 1C according to some embodiments of the present invention; In FIG. 3 it is assumed that the object to be augmented has already been selected and his model and relevant templates are available. The image of the target environment is obtained using Camera 146, while the Augmented Reality superposition result is shown using Display 144 to end-user 148. Locating the target location, object adjustment to match it and the superposition process itself are done by Augmented Reality Application block 142; end-user 148, besides selecting the objects to be superposed, optionally assist in the superposition adjustment process using the User Platform 140 interactions means.

The Target Locator 310 is responsible on calculating the target location and adjustment parameters of the augmented object model for being exactly matched to the target environment model at the target environment image given by Camera 146; it optionally assist in the process by using templates given by a local storage Templates unit 330. Target Locator 310 has few stages of processing, and optionally asses his confidence in accomplishing his mission. In case of insufficient confidence, by using AOI Rendered 340, Target Locator will optionally chose to show to the end user 148 through Display 144 some AOI (Area Of Interest) that will optionally be interactive points, shapes or areas that are superposed by Composer 350 over the target environment image and that will optionally, if needed, also be adjusted by end user 126 and affect the Target Locator calculations. The said AOI or some of its elements will optionally be hidden by Target Locator if achieving sufficient confidence and alternatively will also be shown constantly to the user or subject to other decision such as until selecting a different object for the superposition. Alternatively or additionally to using AOI, the user also interact directly with the superposed object, using simple means such shifting and scaling graphical controls shown to him, implemented for example by an interactive scaling bar and a dragger, accordingly. The said adjustments parameters calculated by Target Locator 310 are operated in Model Matcher 360 over the selected object model 142 in order to accurately adjust the 2.5D model to its target location and wrapping to match its placing in the target environment. After said adjustments the adjusted 2.5D model is rendered into a 2D image and superposed over the target environment by Composer 350, and the final augmentation result is shown on Display 144 to end user 126.

According to some embodiments of the invention the Augmented Reality Application superposes objects also over a video scene. In reference to FIG. 3, Target Locator 310 provides also tracking functionality to track the target location of the superposed object over the video frames, and Model Matcher 360 provides also animating functionality to match the 2.5D model of the superposed object along the video frames. Target Locator 310 will now be further detailed in accordance to some embodiments of the invention. Pre-Processor 312 pre-process the incoming image or video frames in order to assist the mission of following blocks that performs image analysis tasks; some of the possible processing of Pre-Processor 312 are optionally Contrast enhancement, Noise filtering, Sharpening, Color balancing, etc. Locator 1 314 is used for rough locating of the target element on which the object will be superposed, within the target environment image. Various examples are Face locating for the purpose of superposing Eyeglasses or Hand locating for the purpose of superposing a watch. Locator 2 316, based on Locator 1 result, further accurately points special areas that need to be traced and tracked, such as Eyes or Hand, in accordance with the above two examples. Locator 3 318, based on Locator 2 result, further accurately points special points that assist in accurately locating the superposed object 2.5D model over its target environment and adjusting the model for being accurately matched to the target environment. In accordance with the two examples given above, for the purpose of Eyeglasses the eyes pupils and at least another point such as on the noise need to be accurately located, in order to allow proportional fitting, and for the watch we need at least two points each on a different edge of the hand, resembling the strap. For superposing on a video environment, the points located by Locator 3 are tracked by Tracker 1 block 320; alternatively or additional other Locators result optionally will be used for tracking. The tracked points or other elements or some of them will then be used to control Model matcher 360. Optionally not always all Locators 1-3 are needed, and sometimes additional Locator blocks are optionally used. The specific configuration is typically related to the target environment, the elements on which the models are to be superposed-on, and the family of superposed objects. The Templates unit 330 provides templates that guide and assist the Locators; in the Eyeglasses example relevant templates might be a head template for Locator 1 and eyes templates for Locator 2. The plurality of relevant templates are usually related to the application type and relevant object family, and is therefore optionally downloaded along with the application and additionally or alternatively along with the objects models; in any case each template is assigned to the specific Locator and relevant objects family and sometimes specific object; usually, a template will serve multiple objects of the same family of objects or even of different families, if applicable. When tracking a target location in a Video scene, AOI Renderer 340 optionally assist the Augmented Reality application process in few methods. Three exemplary methods are described below, but additional will optionally be used:

Method 1: Initial marking of object over target location: Rough initial location boundaries are drawn and the end user 126 needs to locate the relevant element of the target environment accordingly. For example, for eyeglasses two ellipse representing the eyes are shown, and the user needs to locate his eyes inside them; doing so actually fulfill two missions—heads & eyes rough locating and setting distance between the eyes, i.e. tasks of Locators 1 and 2; at the watch example, a strip might represent the watch and end user 126 needs to locate his hand accordingly.

Method 2: Exact marking of target location points that assist in accurately locating the superposed object 2.5D model over its target environment, i.e. tasks of Locator 3; such points are shown to the user that optionally adjust them. For example, for eyeglasses two crosses representing the eyes pupils are shown, and the user needs to shift them until they are located exactly on the pupil centers.

Method 3: Manual adjustment of the superposed object location, such as adjusting eyeglass or watch positions. As this is done using the superposed object image, in such case the AOI is optionally defined as the superposed object itself.

The various methods optionally mixed upon need; for example, only if automatic location process does not result in sufficient confidence level, markers will be shown to the user for his manual adjustment. In the Eyeglasses example, Locator 3 will use the red crosses only if automatic location of the pupils have been failed.

Various optional flows exist between the Locators to the Tracker 1 block 320 in locating targets at video sequences. One preferred flow in accordance with some embodiments of the invention is to first have the exact target location defined using the Locators, and after having sufficient confidence, use Tracker 1 block 320 through rest of the frames; optionally a confidence level of the tracking is calculated and if reaching too-low level, the Locators mechanism will re-activated. In additional flow, the Tracker 1 produces a ROI (Region Of Interest) of which for each consecutive frame, the Locators are used for the exact location finding. Additional options for flows will optionally be used in accordance with specific objects families and environments types.

Model Matcher 360 receives the 2.5D model of the selected object and has three main blocks; Wrapper 366 adjust the 2.5D model per exact locations received from Target Locator 310; In case of Video image, Animator 364 optionally animate the 2.5D model per locations received from target Locator 310, and Renderer 362 renders the adjusted 2.5D model into a 2D representation to be superposed by Composer 350 over the target environment image or video sequence. Even in case of Video image, Wrapper 366 is optionally activated per each frame those avoiding the need for Animator 364, however this might be less efficient in term of computational load and resources required by Augmented Reality Application 142 from User Platform 140.

As already written in accordance with some preferred embodiments of the current invention, the 3D-like, called also 2.5D model of the objects are photo-realistic vectors based, and in such case Wrapper 366 is using adjustments of vectors, Animator 364 uses skeleton adjustment, and Renderer 362 renders the vectored representation into a 2D image. This process, by avoiding to wrap each frame image but rather just adjust the vectors, ensures high efficiency and relatively small computational and resources load over User Platform 140, and allow usage of limited computational power platforms such as mobile phones. According to some embodiments of this invention the photo realistic vector based modeling and model matching processes optionally use Synthesized Texture technology defined by ISO MPEG-4 part 19 ISO/IEC 14496-19, originally known as VIM and developed by Vimatix Inc. In such case Target Locator located and tracked points need to be in accordance with the 2.5D model vectors or skeleton. This is assured either directly by Target Locator using Vector based templates, or by relatively tying the located points and areas over the vectored models.

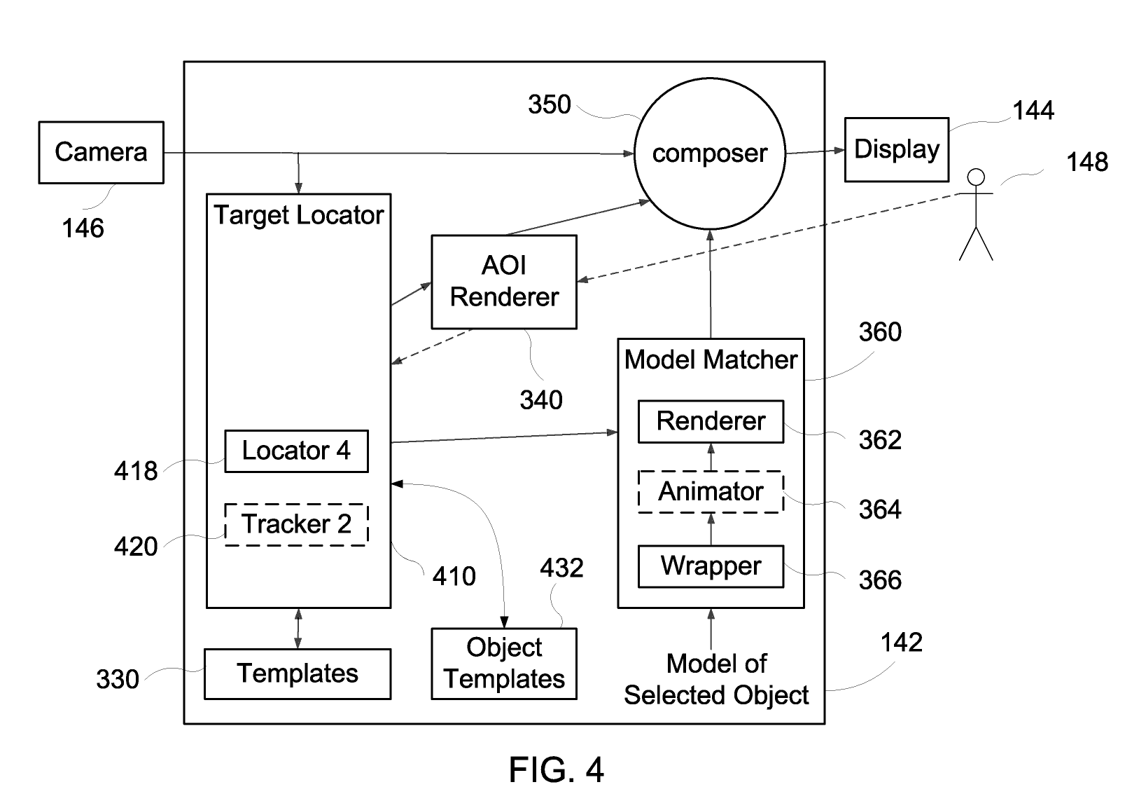

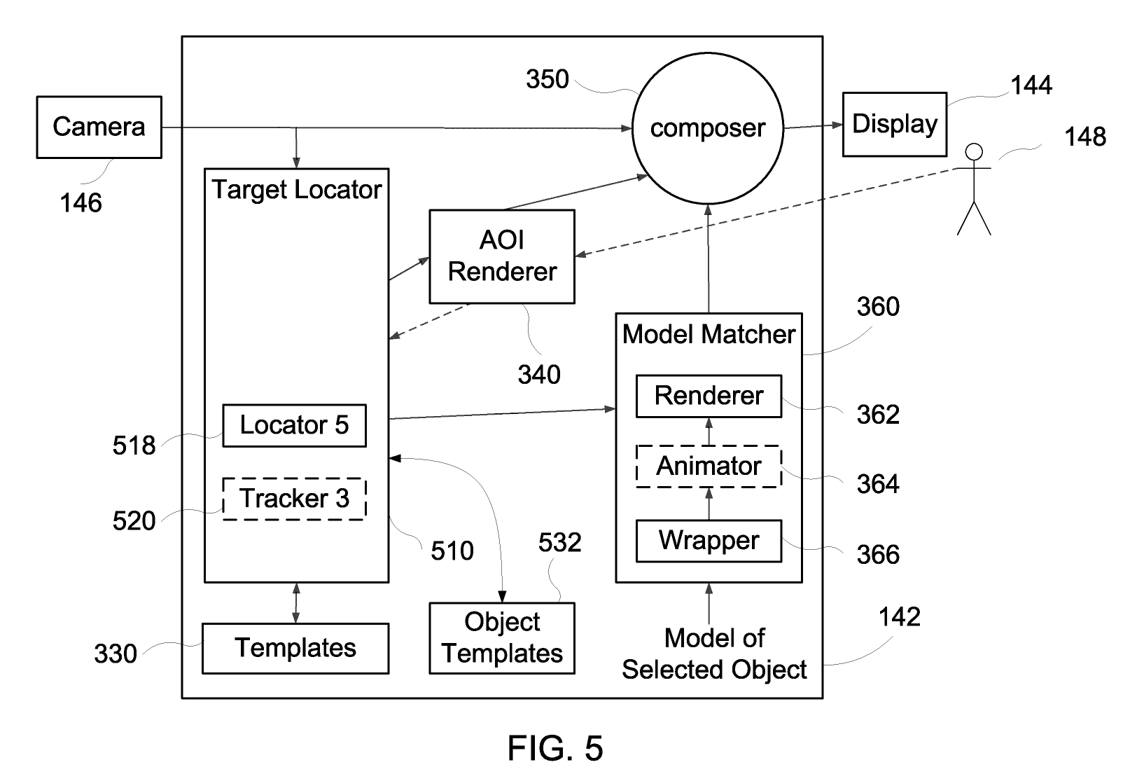

Target Locator 310 is optionally extended to support also locating the target location at the target environment even if it's completely or partially occluded by an object of the same kind of the object that is desired to be augmented over the target location, and the process of locating the said target location optionally automatically overcome the occlusion. There are two optional situations; in the first one the occlusion is translucent hiding significant areas of the target location vicinity, such as a watch over a hand. In such case Target Locator needs to use various possible matching templates. This is further described by FIG. 4. In the second situation, the occlusion is transparent or hiding relatively small areas of the target location vicinity, such as in eyeglasses that need to be replaced with augmented ones, in which the current frame might be desired to be considered. This is further described by FIG. 5.

### Eyeglass Example

Below appears an example using Eyeglasses is given in order to demonstrate a typical operation of the Augmented Reality System composed of Items Provider 100, Augmented Reality Application Platform 120, Items Website 130 and User Platform 140; the example description is divided into two sections—Items provider flow from items images acquiring through the Augmented Reality Application Platform and up to populating the Items Website, and End-user actions-driven flow from selecting a model through interacting with the Items Website and up to viewing the augmented item over its target environment. The items provider flow contains, by way of a non-limiting example, the following typical stages:

Stage 1: Item Provider 100 put in Image Database 102 a library of images of eyeglass frames—“Frames”; each frame having three images each taken from a different angle, such as front, side and 30 degrees from top, in accordance with the pre-known needs of the Augmented Reality Application Platform. Each frame and its images have unique model ID, unique family, and angle ID. The library also contains all relevant meta-data organized is a separate record, defining per the relevant ID's the frames families, the various images per frame, frame real size, frame model name, frame optional colors, frame release date, etc. The Image Database 102 is opened for access over the Web Network 110 by Augmented Reality Application Platform 120. Note that in this example the representative image for the end user's selection purpose as described elsewhere in this invention, will use the 2.5D model of the object; therefore the meat-data indicates this too as well, as the orientation of the shown rendered model for that purpose.

Stage 2: Once in a day, Augmented Reality Application Platform 120 access over the Web Network 110 the Items Images Database 102, fetch the said meta-data record, and identifies the new frames. The images of these frames are then fetched from the Items Images Database into Items Images Storage 210 of Augmented Reality Application Platform 120.

Stage 3: The metadata of each new frame is evaluated and if it frame is not belonging to a new family, each of the frames images are fetched from Items Images Storage and vectorized and extracted by Object Vectorizing 230; first the image is vectorized by Image Vectorization 232, and then it extracted by Object Extraction 234 using a relevant template fetched from Templates & Skeletons Database 220 per the current family. Operator 126 views the result and optionally refines it if needed.

Stage 4: This is an optional stage, effective in case there are new frames that belong to new families. In case the evaluation of the metadata of all new frames reveals that there are new frames that are belonging to at least one new family of objects, Operator 126 is alerted and need to assign templates and skeletons for the new families. He then reviews all the frames that belong to each new family, and tries to assign one of the existing templates including their skeletons, to each of the new families. If he can't find a matching template for a certain family of frames, he needs to conduct a process of defining a new matching templates set and skeletons. New families frames that have their templates assigned, goes back through Stage 3. It is understood that in order to save time, stage 4 or parts of it optionally will be conducted in parallel or prior to stage 3. Optionally a family needs few types of templates, in such case this is recorded too by the Application Platform and treated accordingly per relevant frames.

Stage 5: This process is done per object, in this case per Eyeglass frame. Object 2.5 Modeling 240 fetches from Object Vectorizing 230 the extracted vectorized object images of all relevant images of the Eyeglass frame, along with all metadata needed to mark the frame and its elements per element, and input them to Correspondence Extraction 242 block. Per the meta data, a 2.5D template matching the Eyeglass family is fetched from Templates & Skeletons Database 220; the template contains a 2.5D model of the eyeglasses family and an attached skeleton connecting its parts, in this case the frame and the two handles. Note that each part optionally have a 2.5D model by itself, in this case the Eyeglasses frame model represents not just the frame front but also its thickness view, and relevant vectors of the elements vectors representation have also depth information to allow hiding hidden elements such as not showing a handle when the head is tilted to the other direction, and assigning perspectives to the frame and handles. The Eyeglasses elements are overlaid on the template and a first correspondence process align them more precisely, including affine transformations (including scaling and rotation) as needed. Regions indication corresponding vectors between elements models are then assigned, followed by a second correspondence process, corresponding elements per the candidate regions of each image. The correspondence matching result is optionally presented to Operator 126 that optionally refine it in case needed.

Stage 6: Image Stitching sub-block 244 maps the correspondence data of neighboring areas in various images of the frames, extracted by Correspondence Extraction sub-module 242, onto the Eyeglasses template and stitches the images into a single Object Model. The stitching result is optionally presented to Operator 126 that refine it in case needed.

Stage 7: The Skeleton relevant to the Eyeglasses model, as received as part of its family template, is mapped by Skeleton Assignment sub-block 246 onto the Eyeglasses model, creating the complete 2.5D Model of the Eyeglasses. The 2.5D model is optionally presented to Operator 126 that refines it in case needed, typically by adjusting the Skeleton and its points of connections with the underlying images.

Stage 8: The Eyeglasses 2.5D complete model and all relevant meta-data are stored in Items Vectored Models Database 122.

The above process flow, listed in stages, may optionally be performed in a different ordering of the stages, as may be understood by a person skilled in the art.

The end-user flow optionally includes the following typical stages:

Stage 1: User 148 having a PC 140 serving as User Platform 140 browses using Microsoft corp. Internet Explorer™ browser to the Items Website 130 website of an online shop selling eyeglasses, through use of Display 144 and interaction means such as Keyboard and Mouse. Inside that site he selects to experience the eyeglasses over his video image. The web site checks if said browser already has the Active-X plug in containing Augmented Reality Application 142. If he already has it the flow continues with Stage 3 below.

Stage 2: This is an optional stage, effective in case the user has not installed yet the Augmented Reality Application 142 on his browser. In such case he is asked to approve downloading and installing to the browser the Active-X plug-in of Augmented Reality Application. Upon approval the Active-X is downloaded from Items Website 130 and installed on the user's web browser.

Stage 3: The Application Active-X window is shown over the Items Website window. Items Website exposes to user 148 a list of eyes gasses models families. The user selects a family he wishes to select a model from to try it using the Augmented Reality Application 142.

Stage 4: User Platform 140 informs the user's selection to Items Website 130. Items Website 130 fetches, using Augmented Reality Application API 132, the models of the eyeglasses belonging to the selected family from the Items Vectored Models Database 122 of Augmented Reality Application Platform 120, and transfer them to User Platform 140 where they are stored by Augmented Reality Application 142. Augmented Reality Application 142 creates a representative rendered image for each of the eyeglasses belonging to the fetched family, using its 2.5D model and according to the meta-data hints, and showing them on a scrolled strip at the side of the Augmented Reality Application 142 Active-X window.

Stage 5: The video image of the target environment, i.e. the user's face and it surroundings, is obtained using Camera 146 of User Platform 140 and is shown to the user over Display 144. Target Locator 310 creates two elliptical circles representing the user's eyes, paints them using AOI Rendered 340 and superposes them over the target environment video image using Composer 350. End User 126 then adjusts his view at the camera shown to him over Display 144, by moving his head, in order to fit his eyes inside the elliptical circles. Target Locator 310 fetches the eyes templates from the Templates unit 330 and tries to match them with the eyes images captured inside the elliptical circles, those locating the user's eyes images. If successful then Target Locator 310 continues with further accurate location of the eyes pupils, and if this is successful he activates its tracker over the eyes pupils, tracking the eyes along the video image sequence. Tracking is done using correlation. If locating the eyes images or the eyes pupils is not successful within 10 seconds, Target Locator, replace the two elliptical circles with two small crosses representing the two pupils are shown to the user, and request the user to drag them using the mouse, over their real location in the image and hit Continue; upon then the Target Locator tracker is activated on small areas around the crosses. Upon start of tracking the elliptical circles or crosses are removed by the Target Locator from the superposition shown to the user, and along the while tracking session, the tracking coordinates are transferred to Model Matcher 360.

Stage 6: Model Matcher 360 fetched the 2.5D model of the first eyeglasses shown on the top of the strip on the right side of the window, adjust the model, i.e. scaling and positioning it including rotation and depth adjustment, per the tracking coordinates received from Target Locator 310, and renders the 2.5D model into a 2D Image, that is then superposed using Composer 350 over the image of user's face. The user 148 then sees in Display 144 the eyeglasses augmented over his face. If he moves his head up to a certain level that is still allowed by the tracking, using the tracking coordinated received from Target Locator 310 the eyeglasses are moved and adjusted accordingly by Model Matcher and properly superposed over his face using Composer 350, i.e. providing dynamic augmentation. Using the mouse, the user optionally navigates over the strip of eyeglasses, and selects a different model to be augmented and shown to him. If tracking drops below a certain level of confidence the Eyeglasses stop moving, and Target Locator 310 returns to eyes matching stage, but without showing the circles; upon relocking the tracker with sufficient level of confidence and achieving proper tracking, the Eyeglasses resumed the dynamic augmentation.

For the sake of simplicity, the above description has focused in augmenting the eyeglasses frame. It is easily extended to include also the eyeglasses handles, in such case additional points will be traced and tracked in order to adjust the handles, while a skeleton will be used to connect them with the frame and properly bound the adjustment per the eyes-glasses overall structure.

The above process flow, listed in stages, may optionally be performed in a different ordering of the stages, as may be understood by a person skilled in the art.

### Handling Occlusions:

Reference is now made to FIG. 4, which is another simplified block diagram illustration of an AR User Platform according to an example embodiment of the invention. FIG. 4 depicts a schematic illustration of an Augmented Reality User Platform, similar to the Augmented Reality User Platform as described by FIG. 3 and therefore most of the descriptions will not be repeated in here, but with an extension that enables augmenting the desired object, wherein the target location is optionally partially or fully occluded by another object, either of the same kind of the augmented object, or a different one, and while the platform decide by itself which is the case, i.e. whether the augmentation is done on an exposed target location at the target environment or is it done over at least a partially occluded one, and act accordingly in performing the augmentation. An exemplary usage is augmenting a watch over a hand, while it is not known a-priory if the user is already wearing a watch or not and if he do wear a watch he is not requested to remove it first. FIG. 4 is similar to FIG. 3, and analogues blocks are indicated by same numbers. The three different extensions are Object Templates 432, that provides templates of objects of families that are of the same type of potential augmented objects, Locator 4 block 418, that extends Target Locator 410 capabilities to handle also occluding objects, and Tracker 2 block 420 to track them; therefore the Target Locator of FIG. 4 although its similar to Target Locator 310 of FIG. 3, is marked in FIG. 4 as Target Locator 410, to emphasize the added capability. For the sack of simplicity only Locator 4 block 418 and Tracker 2 block 420 are shown inside target Locator 410 in FIG. 5, although he contains also other blocks equivalent to blocks residing in Target Locator 310 of FIG. 3.

Object Templates 432 provides a local storage for templates of family objects that are of the same type of the objects that are desired to be augmented. They optionally contain templates of various families as stored also in Templates unit 330 as well as templates of additional possible families. Optionally a limited configuration will use Templates unit 330 itself instead of Object Templates 432, and an extended configuration optionally uses both instead of duplicating templates. According to exemplary embodiment of the invention, new templates for Object Templates 432 are optionally prepared by Operator 126, stored in Augmented Reality Application Platform 120 and retrieved as part of augmented reality Application 142 or retrieved by it upon need through Items Website 130. Other optional methods are possible as well. Locator 3 318 (belongs to Target Locator 410 but not shown in FIG. 4), initially tries, to accurately points special points that assist in accurately locating the superposed object 2.5D model over its target environment and adjusting the model for being accurately matched to the target environment; in this process Locator 3 uses Templates from Templates unit 330 storage to assist him, and if the process does not result in sufficient confidence level of success, Locator 4 join the effort using Templates from Object Templates storage 432, trying to locate special points related to occluding object, such as a current watch resides on a hand that the user wishes to augment a model of a different watch. In case of a Video scene, if Locator 4 achieve sufficient level of confidence, Tracker 2 block 420 meant be used to track the special points on subsequent frames; Tracker 2 is drawn in the diagram to emphasize it is tracking occluding objects elements rather than exposed target environment elements; although Tracker 1 can also optionally be used for that mission, in case both special points of the target location exposed area and special points of an occluding object are desired to be tracked, Tracker 2 is needed. In a further embodiment of the current invention Locator 4 block 418 optionally mix usage of Templates in its mission, as well as use only sections of templates, those resulting in also being capable to successfully handle situations of mixed occlusion and clear visibility of the target. Further optionally, Object Templates 432 contains templates representing different objects type families that optionally occlude either fully or partially the target location, those extending the robustness of the platform and solution; For example, templates of wristlets will optionally be used upon trying to locate the target location for a watch.

Similarly to as explained in relation to FIG. 3, and also in relation to FIG. 4, not always all Locators are needed, and sometimes additional Locator blocks are optionally used. The specific configuration is typically related to the target environment, the elements on which the models are to be superposed-on, and the families of superposed objects and optional occluding objects.

Those skilled in the art will readily appreciate that various modifications and changes can be applied to some of the embodiments of the present invention to allow augmenting an object that is based on either 2D or 2.5D or 3D model, wherein the target location is optionally partially or fully occluded by another object, either of the same kind of the augmented object, or a different one, and while the platform decide by itself which is the case, i.e. whether the augmentation is done on an exposed target location at the target environment or is it done over at least a partially occluded one, and act accordingly in performing the augmentation.

Reference is now made to FIG. 5, which is a simplified block diagram illustration of an AR User Platform according to an example embodiment of the invention. FIG. 5 depicts a schematic illustration of an Augmented Reality User Platform, similar to the Augmented Reality User Platform as described by FIG. 3 or by FIG. 4, but with an extension that enables augmenting the desired object more accurately, wherein the target location is partially or fully occluded by an object of the same kind of the augmented object, while some parts of the occluding object are transparent, and while the platform optionally decide by itself which is the case, i.e. whether the augmentation is done on an exposed target location at the target environment or is it done over at least a partially occluded one, or is it done over at least partially transparent object, or any relevant combination, and act accordingly in performing the augmentation. An exemplary usage is augmenting eyeglasses over a face, while it is not known a-priory if the user is already wearing eyeglasses or not and if he do wear such he is not requested to remove them first. FIG. 5 is similar to FIG. 4, and analogues blocks are indicated by same numbers. The three different extensions are Object Template block 532 that provides templates of objects of families that are of the same type of potential augmented objects similarly to Object Templates 432 of FIG. 4 including representing also objects that are optionally partially transparent, Locator 5 block 518 that extends Target Locator 510 capabilities to locate elements of partially transparent occluding objects, and Tracker 3 block 520 to track them; therefore the Target Locator 510 of FIG. 5 although similar to Target Locator 310 of FIG. 3 and Target Locator 410 of FIG. 4, is marked in FIG. 5 as Target Locator 510, to emphasize the added capability; also, for the sack of simplicity only Locator 5 block 518 and Tracker 3 block 520 are shown inside target Locator 510 in FIG. 5, although he contains also other blocks equivalent to blocks residing in Target Locator 310 of FIG. 3 and Target Locator 410 of FIG. 4.

Object Template 532 provides a local storage for templates of family of objects that are of the same general type of the objects that are desired to be augmented, serving also types of objects that are transparent in some of their sections, such as eyeglasses frames. They optionally contain templates of various families as stored also in Templates unit 330 as well as templates of additional possible families. Optionally a limited configuration will use the Template unit 330 instead of Object Templates 532, and an extended configuration will optionally use both instead of duplicating templates. According to exemplary embodiment of the invention, new templates for Object Template 532 are optionally prepared by Operator 126, stored in Augmented Reality Application Platform 120 and retrieved as part of augmented reality Application 142 or retrieved by it upon need through Items Website 130. Other methods are possible as well. Locator 5 518, tries, similarly to Locator 4 418 of FIG. 4, to accurately points special points that assist in accurately locating the superposed object 2.5D model over its target environment including locating special points that belongs to non-fully transparent elements of occluding objects that are at least partially transparent, and adjusting the model for being accurately matched to the target environment; similarly to as described in relation to FIG. 4. Locator 3 uses Templates from Templates unit 330 storage to for initial location of relevant special points, and if the process does not result in sufficient confidence level of success, Locator 4 optionally try using also Templates from Object Template storage 532 that contains optionally occluding objects as described in relation to Object Templates 432 of FIG. 4 and its usage, and Locator 5 tries to locate special points related to the translucent elements of the templates, using optionally partially-transparent occluding objects stored on Objects Storage 532, such as eyes-glasses frame, in such case even if the eyes pupils are not be identified, using the frame of the current eyes-glasses that the user wear optionally help to locate the augmented pair. In case of a Video scene, if Locator 5 achieve sufficient level of confidence, Tracker 3 block 520 meant be used to track the special points on subsequent frames; Tracker 3 is drawn in the diagram to emphasize it is tracking occluding semi-transparent objects elements rather than exposed target environment elements; although Tracker 1 or Tracker 2 can optionally also be used for that mission, in case both special points of the target location exposed area and special points of an occluding object are desired to be tracked, Tracker 3 is needed. In a further embodiment of the current invention Locator 518 optionally mix usage of Templates in its mission, as well as use only sections of templates, those resulting in also being capable to successfully handle situations mixed occlusion and transparencies of the target location by an object of the same kind of the augmented object. Object Template 532 optionally contains templates representing different objects type families that optionally occlude either fully or partially the target location, those extending the robustness of the platform and solution, such as explained in relation to FIG. 4. Using a mix confidence level calculation is optionally applied, such as considering the confidence level of finding and tracking eyes pupils as well as current eyeglasses frame.

Similarly to as explained in relation to FIG. 3 and FIG. 4, also in relation to FIG. 5 not always all Locators and Trackers are needed and sometimes additional Locator blocks or Trackers optionally will be used. The specific configuration is typically related to the target environment, the elements on which the models are to be superposed-on, and the families of superposed objects and optional occluding objects.

Those skilled in the art will readily appreciate that various modifications and changes can be applied to some of the embodiments of the present invention to allow augmenting an object that is based on either 2D or 2.5D or 3D model, wherein the target location is optionally partially or fully occluded by another object, either of the same kind of the augmented object, or a different one, and while the platform decide by itself which is the case, i.e. whether the augmentation is done on an exposed target location at the target environment or is it done over at least a partially occluded one, or is it done over at least partially transparent object, or any relevant combination.

### Apparatus for Target Locating and Tracking:

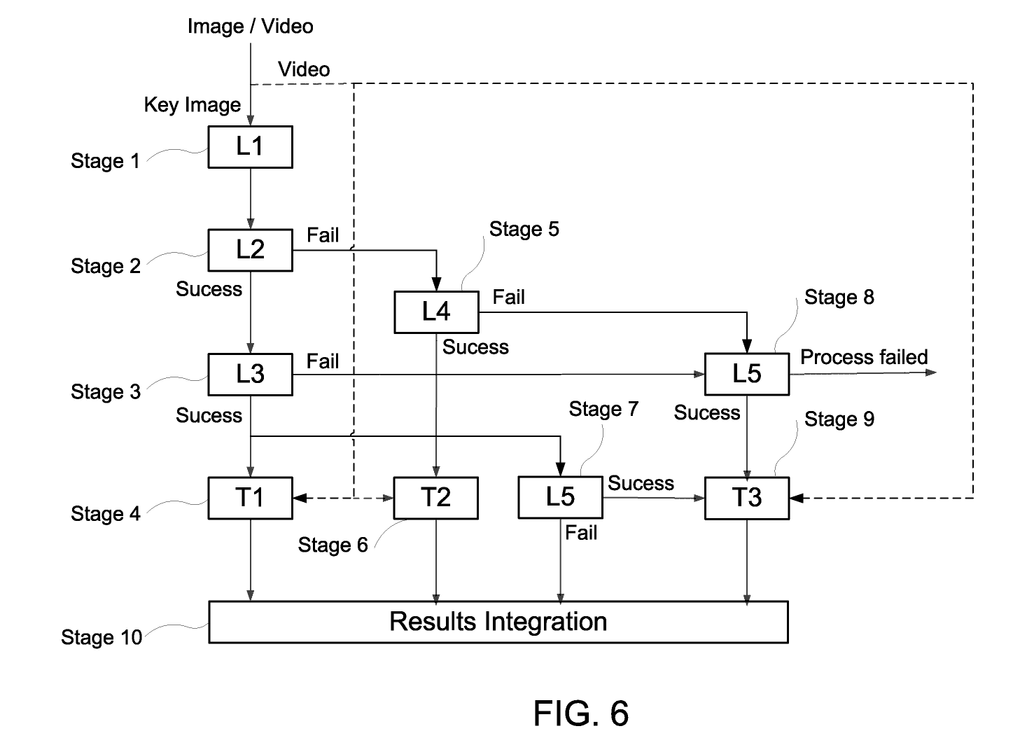

Reference is now made to FIG. 6, which is a simplified flow chart illustration of locating a target and tracking the target, used in the example embodiment of FIG. 5. FIG. 6 provides a schematic diagram of an example of using Eyeglasses is given in order to demonstrate a typical operation of the Target Locator 510 of the Augmented Reality Platform described by FIG. 5, according to some embodiments of the present invention. Note that single image path is marked in FIG. 6 as started with Key image, while the dotted lines in FIG. 6 indicate Video input for consecutive frames if tracking is needed:

Stage 1: Locator 1 locates the end user head.

Stage 2: Locator 2 tries to locate the end user eyes areas. If success, then go to stage 3. If not, then go to stage 5; this might happen for example if the user is wearing sun-glasses.

Stage 3: Locator 3 locates the eyes pupils; if success, go to stages 4 and 7. If failed, goes to stage 6.

Stage 4: Tracker 1 tracks the eyes pupils. Then go to stage 10.

Stage 5: Locator 4 tries using occluding Object Template, attempting to locate special points related to such. If success, then go to stage 6. If not, then go to stage 8.

Stage 6: Tracker 2 tracks the occluding object. Then go to stage 10.

Stage 7: Locator 5 tries lo locates special points belonging to current eyes-glasses frame. If fails then go to stage 10. If success, continue to stage 9.

Stage 8: Locator 5 tries lo locates special points belonging to current eyes-glasses frame. If failed then the automatic process is failed. If success, continue to stage 9.

Stage 9: Tracker 3 tracks the eyeglasses frame. Then go to stage 10

Stage 10: The results of tracker 1, tracker 2 and tracker 3, if applicable, are gathered to provide an intelligent integrated result. If for example tracker 1 and tracker 3 results are applicable, tracker 3 will be used to stabilize the tracker 1 result and better position the new eyeglasses frame based on the current one. In another example if tracker 1 result is applicable but Stage 7 result is Fail, the only tracker 1 result will be used.

The above process flow, listed in stages, may optionally be performed in a different ordering of the stages, as may be understood by a person skilled in the art.

The above example given in FIG. 6 is only an exemplary embodiment, and it optionally extended to support additional cases, and using less or more locators and trackers. It is be further noted that block L5 appears twice in FIG. 6, used under both Stage 7 and Stage 8, and both direct in case of success to block T3 used under stage 9; This example demonstrates a certain configuration involving same Locator and same Tracker under different circumstances at the same general flow, those being a private example of a configurable apparatus that is capable to use various locating and tracking blocks, sequenced per the relevant case, but without a-priori knowing the exact scene and occlusions, in order to perform automatic integrated locating and optional tracking of target locations and occluding objects and integrating the superposed result for the purpose of augmenting a desired object over an exact target location. Similar configuration configurable apparatus that is capable to use various locating and tracking blocks, sequenced per the relevant case, optionally will be used in order to perform automatic integrated locating and optional tracking of target locations and integrating the superposed result for the purpose of augmenting a desired object over an exact target location, as part of Target Locators 310 of FIG. 3 and Target Locator 410 of FIG. 4.

### Painting:

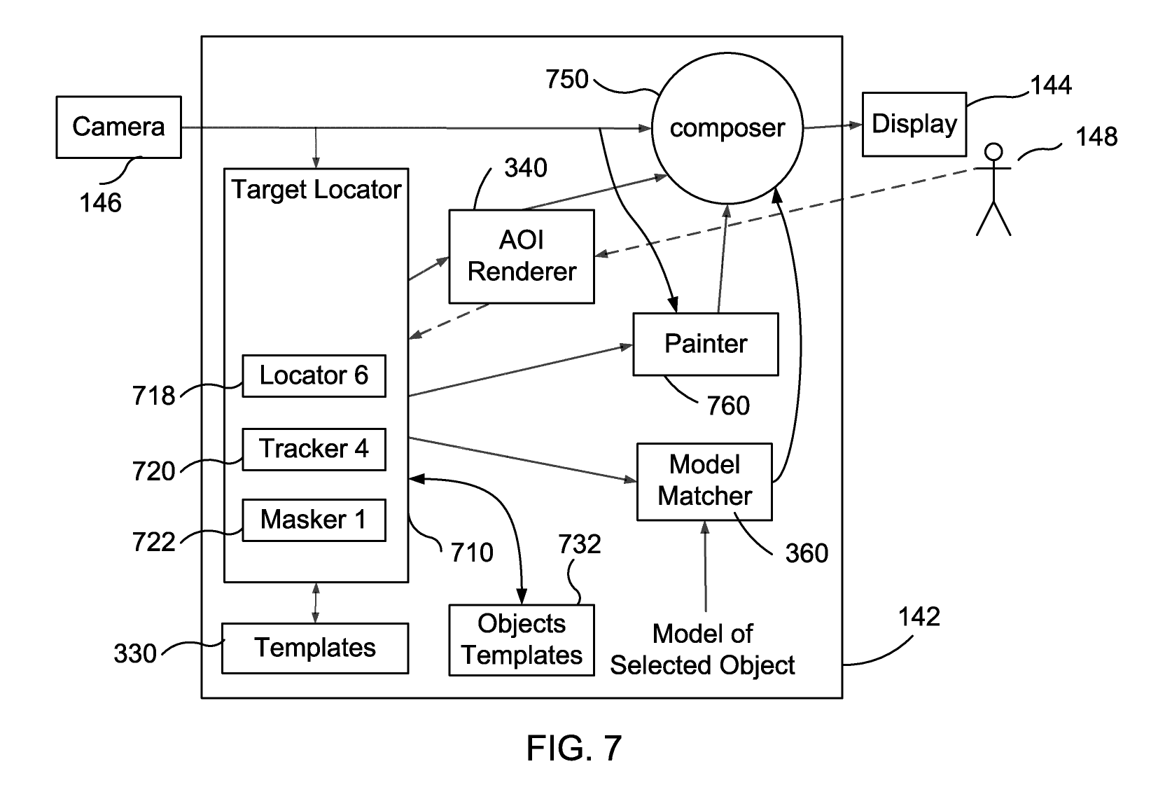

Reference is now made to FIG. 7, which is a simplified block diagram illustration of an AR User Platform according to an example embodiment of the invention. FIG. 7 depicts a schematic illustration of an Augmented Reality User Platform, similar to the Augmented Reality User Platform as described by FIG. 5, but with an extension that enables painting areas belonging to the original image or video and that are desired be replaced for the purpose of the augmented reality augmentation of objects over original objects that need to be hidden, according to some embodiments of the present invention. An exemplary usage is when superposing an object that is at least partially smaller, then an original object that resides at the user's target environment, such as augmenting a watch or a ring over a smaller one or augmenting a wrist over a watch. FIG. 7 is similar to FIG. 5, and analogues blocks are indicated by same numbers. The extended and new blocks are:

Object Template block 732 that provides templates of objects of families that are of the same type of potential augmented objects similarly to Object Templates 432 of FIG. 4 and block 532 of FIG. 5 including representing also objects that are optionally partially transparent but is marked differently as might also provides templates serving painting, and

Locator 6 block 718 that is basically extends Target Locator 710 capabilities to assist locating areas for painting;

Tracker 4 block 720 to track them;

Masker 1 block 722 creating mask for areas that needed to be painted;

Target Locator 710 of FIG. 7 although similar to Target Locator 410 of FIG. 4 and Target Locator 510 of FIG. 5 and therefore is capable to locate occluding objects and translucent elements of partially transparent occluding objects, is marked in FIG. 7 as Target Locator 710, to emphasize the added capability in pointing areas to be painted, and for the sack of simplicity only Locator 6 block 718, Tracker 4 block 720 and Masker 1 block 722 are shown inside target Locator 710, although he contains also other blocks equivalent to blocks residing in Target Locator 310 of FIG. 3, Target Locator 410 of FIG. 4, and Target Locator 510 of FIG. 5;

Painter block 760 that serves as brush for painting areas of the target environment according Locator 6, Tracker 4 and Matcher 1 instructions; and

Composer 750 that is similar to Composer 350 of FIG. 3, FIG. 4 and FIG. 5, but with an additional input for superposing the Painter Block 760 painting over the target environment.

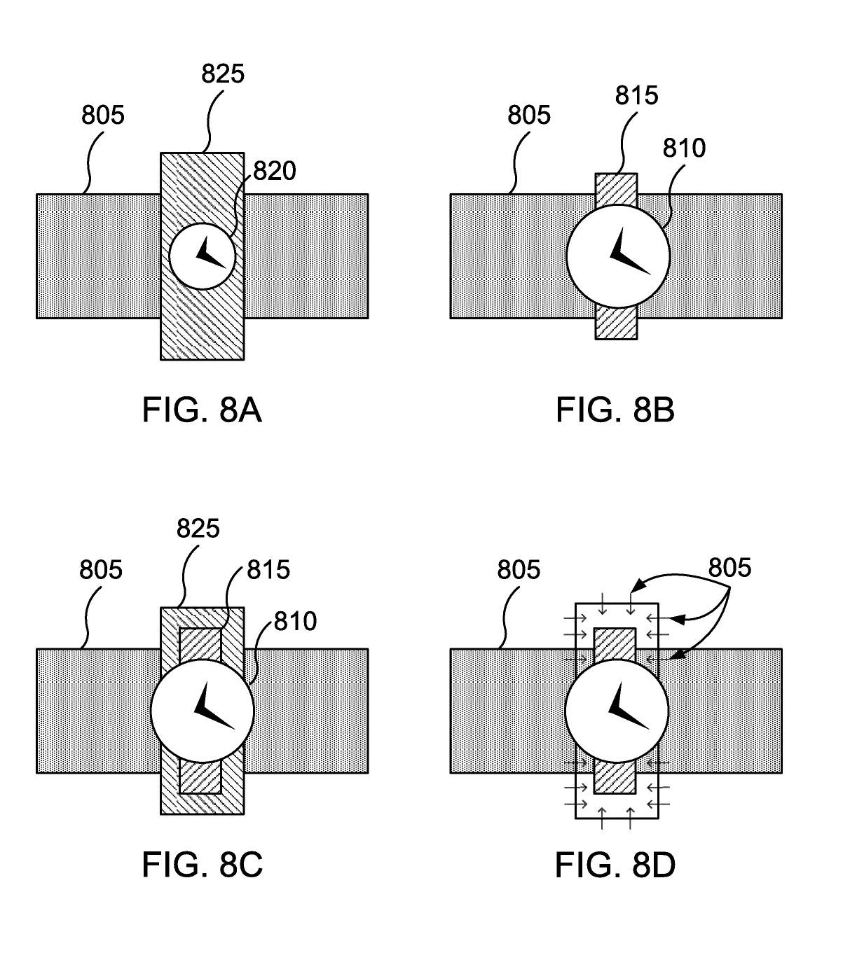

Target Locator 710 that optionally has the capabilities of Target Locator 410 of FIG. 4 and Target Locator 510 of FIG. 5, is capable as explained in relation to FIG. 4 and FIG. 5, to locate areas that belong to occluding objects and transparent and translucent areas of partially transparent occluding objects; similar, Target Locator 710 knows how to identify such situations and optimize the superposition of the desired object model over its target location at the target environment and stabilized it in a video image. Knowing the area that the superposed object capture in each frame of the superposition, and the area of occluding elements of occluding objects, Locator 6 block 718n calculates the difference that indicate on areas that after the superposition are still showing occluding elements that distract the appearance of the augmentation process and provide a mask that accurately points on them, while Tracker 4 helps to track these areas over the video frames those providing a complete mask of such areas over the video sequence. It is understood that Locator 6 by itself can optionally act on all frames of a Video image and in such case Tracker 4 block 720 optionally be seemed as redundant, but even in such case Tracker 4 by using predication algorithms, provide the estimated area to be painted even if at some frames Locator 6 does not have sufficient information, those potentially elevating the reliability of the relevant areas extraction and mask creation. Masker 1 block 722 considers the masks create by Locator 6 and Tracker 1, and considering relevant templates from Templates unit 330 and Object Template 732, extend the masks creating a mask with intelligent painting hints for painting the areas that the mask covers, while the hints indicate the painting source for various region that the mask points on them at the target environment image. For example, if a large watch having a thin strap is to be superposed over a smaller watch but with a wider strap, the original strap edges that are across the hand are occluding hand elements and therefore the difference is indicated by a mask pointing on near straps of the hand as the source for painting by cloning, while the strap two edges that are parallel to the hand border typically use cloning from a near area outside the hand for painting. This is further demonstrated by FIG. 8A to FIG. 8D of the present application. In another example, Eyeglasses area to be augmented over a face of a person wearing a different eyeglasses, in such case Masker 1 will indicate of areas of the frame of the original eyeglasses that are not covered by the frame of the new eyeglasses, while the hints for painting will involve a mixed cloning of areas near the two sides of the original frame.

Painter 760 receives from Target Locator 710 the masks of areas that need to be painted and the hints for painting them, and performs the painting itself. The painting is using cloning of near-by areas, i.e. trying to continue the look of the vicinity that is external to superposed and occluding objects; therefore, Painter 760 is getting also the camera image, and Video in case relevant, enabling it to look at said vicinity areas per frame and use them for the purpose of cloning. An example of using hints is given by FIG. 8A to FIG. 8D of the present application. The cloning itself optionally use small copying brush similar to the cloning tool in image and video processing common utilities, or use alternative methods such as cloning by photo realistic vectors extracted from the images and re-used for the cloning, using technologies such as the Synthesized Texture technology defined by ISO MPEG-4 part 19 ISO/IEC 14496-19, originally known as VIM and developed by Vimatix Inc.

Those skilled in the art will readily appreciate that various modifications and changes can be applied to some of the embodiments of the present invention to allow augmenting an object that is based on either 2D or 2.5D or 3D model, while painting areas belonging to the original image or video and that are desired be replaced for the purpose of the augmented reality augmentation of objects over original objects that need to be hidden.

Reference is now made to FIGS. 8A-8D, which are simplified illustrations of an example of augmenting a large watch having a thin strap over a smaller watch having a wider strap, according to an example embodiment of the invention.

FIGS. 8A-8D provide a schematic diagram of an example of augmenting a large watch 810 having a thin strap 815 over a smaller watch 820 having a wider strap 825, along with painting relevant occluded areas, in order to demonstrate a typical operation of the Target Locator 710 mask preparation and Painter 760 of the Augmented Reality Platform described by FIG. 7, according to some embodiments of the present invention.

FIG. 8A shows a section 805 of a user's hand indicated by a dotted pattern, wearing a watch 820 with a wide strap 825 indicated by an up-left direction of a diagonal line pattern.

FIG. 8B shows the same user hand section 805 as in FIG. 8A indicated by the dotted pattern, wearing the desired watch 810 having a thin strap 815 indicated by an up-right direction of a diagonal line pattern.

FIG. 8C shows an augmentation result if painting is not employed; the wider strap 825 of the original watch 820 indicated by an up-left direction of a diagonal line pattern is seen beneath the thinner strap 815 of the augmented watch 810 indicated by an up-right direction of a diagonal line pattern.

FIG. 8D shows a result of augmentation after painting is optionally used; in the present example painting is of a cloning type, using nearby areas as indicated by arrows 830. Remains of the wider strap 825 of the original watch 820 as seen in FIG. 8C are replaced by a pattern and/or background of the hand section 805, accordingly, in relevant areas. The augmentation result is now as desired, similar to as seen in FIG. 8B.

### Background Replacing:

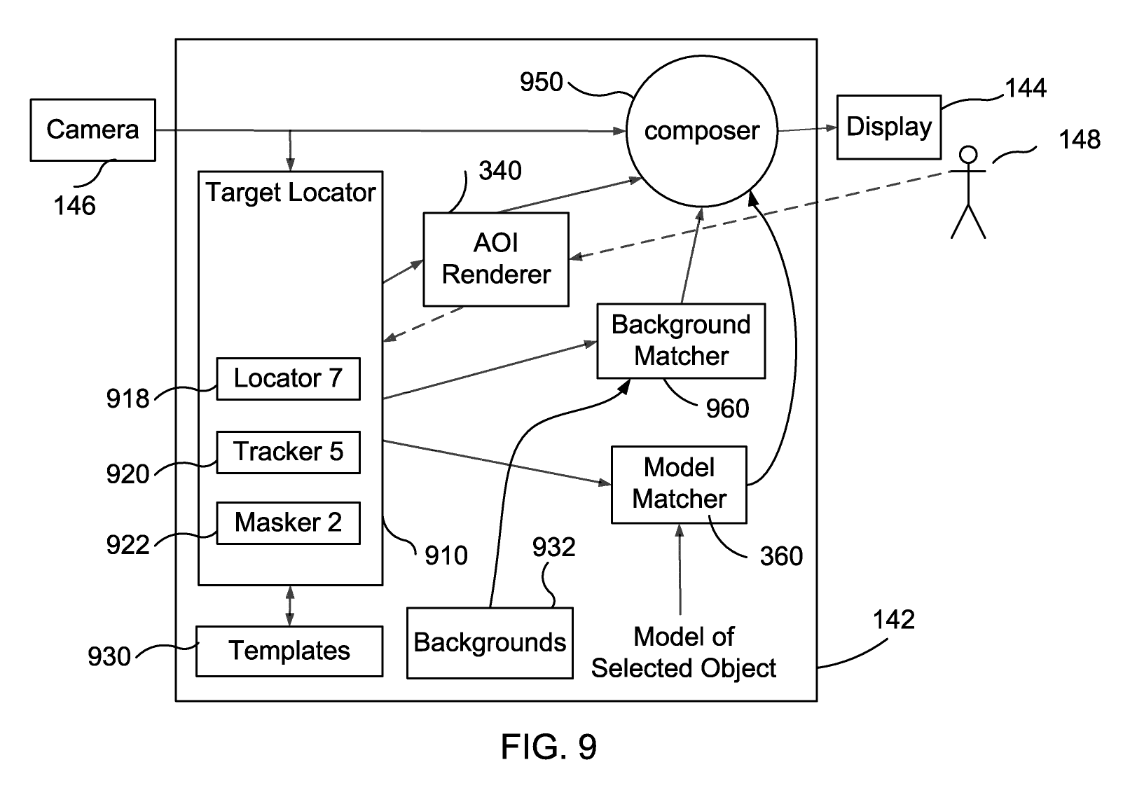

Reference is now made to FIG. 9 which is a simplified block diagram illustration of an AR User Platform according to an example embodiment of the invention. FIG. 9 depicts a schematic illustration of an Augmented Reality User Platform, similar to the Augmented Reality User Platforms as described by FIGS. 3-5 and 7, but with an extension that enables replacing the background of the user of whom the desired object is augmented, completely or sections of it, according to some embodiments of the present invention; An exemplary usage is replacing a room image that is the real background of the head of a person that tries various sunglasses using Augmented Reality with in image or video of a Greek island beach. FIG. 9 is similar to FIG. 3, and corresponding blocks are indicated by same numbers. The extended and new blocks are:

Templates block 930 that provides all required templates and Object Template similarity to blocks 33 of FIG. 3, 432 of FIG. 4, block 532 FIG. 5 and Block 732 of FIG. 7, as well as templates representing the user's image in the context of the augmentation application, such as heads with short and long hair, hands, upper section of mans and women's bodies;

Backgrounds block 932 that provide a local storage for background images and videos that optionally are selected by the user to replace his actual background. According to exemplary embodiment of the invention, such backgrounds are optionally prepared by Operator 126, stored in Augmented Reality Application Platform 120 and retrieved as part of Augmented Reality Application 142 or retrieved by it upon need through Items Website 130; alternatively they are inserted by the user itself;

Locator 7 block 918 that is basically extends Target Locator 910 capabilities to isolate the user's image;

Tracker 4 block 920 to track it;

Masker 1 block 922 creating mask representing the user's image;

Target Locator 910 of FIG. 9 although similar to Target Locators 310 of FIG. 3, 410 of FIG. 4, Target Locator 510 of FIG. 5 and Target Locator 710 of FIG. 7, and therefore is capable to locate occluding objects and translucent elements of partially transparent occluding objects and pointing areas to be painted, is marked in FIG. 7 as Target Locator 910, to emphasize the added capability in, and for the sack of simplicity only Locator 7 block 918, Tracker 5 block 920 and Masker 2 block 922 are shown inside target Locator 910, although he contains also other blocks equivalent to blocks residing in Target Locator 310 of FIG. 3, Target Locator 410 of FIG. 4, Target Locator 510 of FIG. 5 and Target Locator 710 of FIG. 7;

Background Matcher 960 that according to Locator 7, Tracker 5 instructions match the selected Background to the superposed image and according to Masker 2 instructions retain transparency through which the users image will be seen rather than being occluded by the new background uses; and

Composer 950 is similar to Composer 350 of FIG. 3, FIG. 4 and FIG. 5, and composer 750 of FIG. 7, optionally with an additional input for superposing the matched background created 760 painting over the target environment while using the mask to retain the user's image itself.

Target Locator 910, with the Locator 7 and Tracker 5 and optionally using also other locators and trackers result, and using templates of relevant templates from Templates block 930 representing sections of the typical end user as supposed to be seen in the image, provide the outline of the user's image, while Tracker 5 helps to track it over the video frames those providing a complete mask of such areas over the video sequence. It is understood that Locator 7 by itself can optionally act on all frames of a Video image and in such case Tracker 5 block 920 will be seemed as redundant, but even in such case Tracker 5 will optionally, by using predication algorithms, provide the estimated area to be masked even if at some frames Locator 7 does not have sufficient information, those potentially elevating the reliability of the relevant areas mask creation. Masker 2 block 922 considers the masks created by Locator 7 and Tracker 5, and considering relevant templates from Templates 930, extends the created mask reliability. As a simple example, if the end user wishes to augment Eyeglasses, Locator 7 will refine Locator 1 face locating results to accurately locate the user's head image. It is understood that in case the superposed object retain areas outside the original image of the user, Masker 2 consider data also from other Locators and Trackers and include this area in the mask it creates.

Background Matcher 960 receives from Target Locator 710 the mask of the end user image, Background Matcher 960 receive from Backgrounds block 932 the image of the desired new background and according to Locator 7 and Tracker 5 instructions it to the superposed image, and according to Masker 2 instructions retain transparency through which the users image will be seen rather than being occluded by the new background used. Composer 950 superposes the new background over the original image, while the mask potentially enables seeing the end user with the augmented object over him.

For the sack of explanation simplicity Painting option as shown by FIG. 7 is not shown in relation to FIG. 9, but it is optionally used as well by the User Platform described by FIG. 9. Also, the process in which the user select the desired background is not shown in here, but it is optionally similar to the process of selecting family of objects that is desired to be augmented and specific objects by for example using thumbnails for preview; for example the user optionally select locations images by selecting from specific places, or by selecting specific attributes, such as Beaches or Snow, and then view a strip of thumbnails from which the desired image will be selected. As background images optionally will need large memory to store, they optionally will be retrieved upon need rather than stored on the user's platform. Alternatively or additionally, representation by photo realistic vectors that is relatively light optionally be used, such as the Synthesized Texture technology defined by ISO MPEG-4 part 19 ISO/IEC 14496-19, originally known as VIM and developed by Vimatix Inc.

Those skilled in the art will readily appreciate that various modifications and changes can be applied to some of the embodiments of the present invention to allow augmenting an object that is based on either 2D or 2.5D or 3D model, while replacing the background of the user of whom the desired object is augmented, completely or sections of it, for the purpose of the augmented reality augmentation of objects over original background or section of it that need to be replaced.

### Selecting by Attributes:

According to a further aspect of some embodiments of the invention there is provided a method and system for using data indicating of real physical attributes related to the end user, for real-time linking along the augmenting process, between the continues scaling options of the 2.5 objects models to the true discreet offered sizes of real objects, such as given finite sizes of eyeglasses that need to be superposed over images of faces, matching as possible its physical sizes. Fore methods are described below as example preferred embodiments of the invention, but additional optionally will be used. In all the exemplary methods shown the process of getting said data is preferably done prior to exposing the user the various selections options in order to filter them first, by Augmented Reality Application 142 at the User's Platform 140; the order of processes and applications flows are optionally changed and refinements are optionally used along the augmented reality sessions, depending also on the specific type of objects and system used; for example, all objects models that are optional for the augmented reality process relating to a chosen family will optionally first be retrieved by Augmented Reality Application 142 and then filtered by the physical attributes data, or alternatively the attributes will first be gathered and used to retrieve only relevant objects models; in a further possibility, the models themselves will optionally be scaled as needed by the Augmented Reality Application. The non-limiting example methods include:

Method 1: As part of the end user's interaction at User Platform 140, before presenting him various selections options, he input relevant constraints, such as clicking the distance between the eyes (PD) for eyeglasses Augmented Reality applications. Additional examples are clicking the Perimeter of his hand or the length of his Watch strap, for hands-watches Augmented Reality applications.

Method 2: Requesting the end user to put at the target environment a reference object with known-size as a hint and extrapolating the size of users' target object at the target environment on which the desired object is to be augmented. The reference object should be placed over the same surface that represent the target measurement; for example for measuring distance between the eyes for having needed parameters for eyeglasses, a sticker with a known size may be used; in another example uses laying a 50 cents coin over the hand on the target location of a hand watch. Optionally also the reference object height over the target objet surface is considered, to compensate for parallax errors. Referencing any of FIGS. 3-7 and 9; this is optionally automated by using another set of templates representing such object, such as a reference circle representing a known coin, and using another Locator or locators or an available one if applicable at Target Locator block, as well as Trackers if needed, along with at least some of the following:

Target Locator identifies the target object, such as a hand for augmenting a watch.

Using the AOI Renderer showing the user the area on which to put the reference object, such as drawing him a circle over his hand and asking him to put over it a 5 cent coin.

A further Target Location action exactly locates the object and its boundaries.

Target Locator calculates the relevant sizes based on the Object and Reference object relative sizes and placement, optionally including also height from surface, at the image, and extrapolate the real sizes of needed elements at the target environment.

The relevant sizes are transferred to Items Website and through there are used to filter the potential objects for augmentation that are relevant for the specific user.

Method 3: Similar to method 3, while the reference object is a measuring element such as a measurement ruler; instead of using a known single size, an OCR is used to analyze the actual sizes the measuring object shows, such as reading the centimeters count, and later using them to extrapolate the objects size by using the sizes ratios over the image.

Method 4: Using built-in known-size hint such as the size of a known hand-watch model, and extrapolating the size of users' target object at the target environment on which the desired object is to be augmented. This process optionally uses user's input on the specific object he wear, or automated identification made with the help of relevant means, such as an OCR module for reading the watch model as written on his surface.

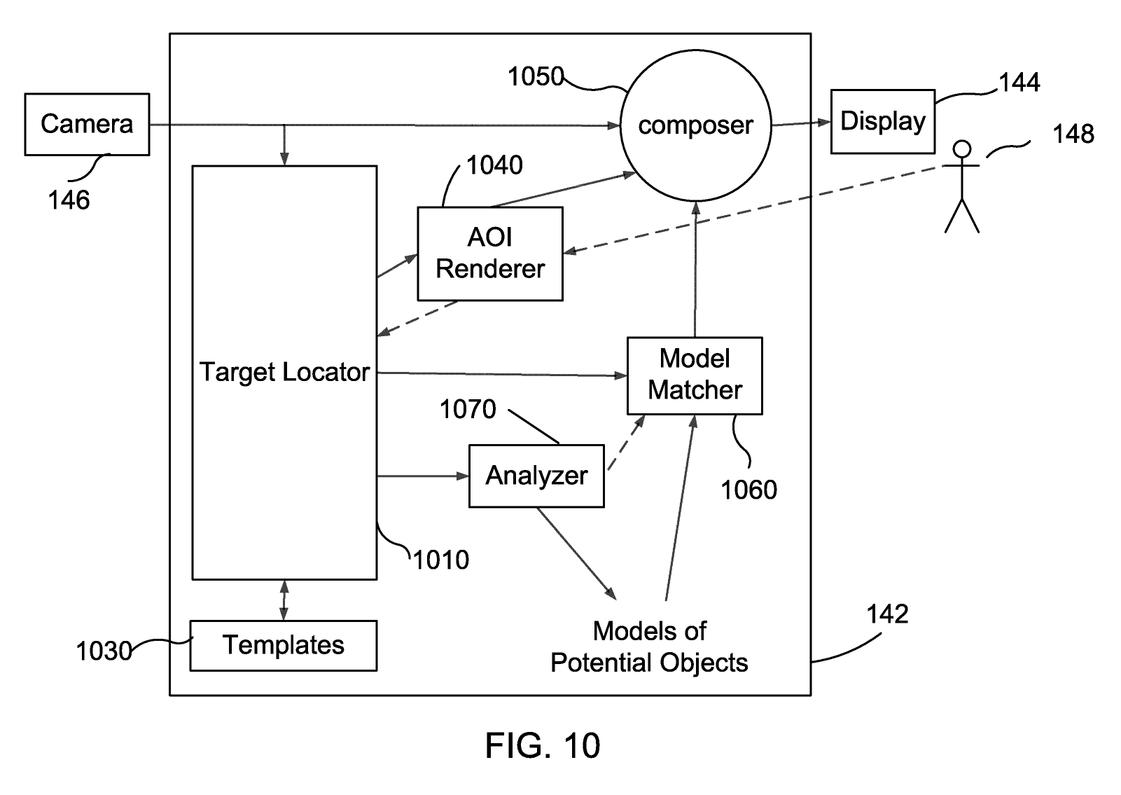

Some of the methods are optionally performed using the User Platform describe by FIG. 10 below. Also, depending on the specific Augmented Reality application, also depth information will optionally be considered in getting size-related data, either by user's input or some references measurements.

Those skilled in the art will readily appreciate that using a reference object with known size can be used for extracting measurements and dimensions needed for implementation of an augmented object, such as PD (Pupillary Distance) that measures the distance between eyes pupils, needed for manufacturing vision glasses lenses.

Those skilled in the art will readily appreciate that various modifications and changes can be applied to some of the embodiments of the present invention to allow augmenting an object that is based on either 2D or 2.5D or 3D model, while using data indicating of real physical attributes related to the end user, for real-time linking along the augmenting process, between the continues scaling options of the objects models to the true discreet offered sizes of real objects that are represented by the models, for the purpose of the augmented reality augmentation of objects.

Reference is now made to FIG. 10 which is a simplified block diagram illustration of an AR User Platform according to an example embodiment of the invention. FIG. 10 depicts a schematic illustration of an Augmented Reality User Platform, similar to the Augmented Reality User Platforms as described by FIGS. 3-5, 7 and 9, but with an extension that allows indicating data of real physical attributes related to the target environment, for real-time linking along the augmenting process, between various image attributes and optionally also inserted references to the optional superposed objects. Target Locator 1010, AOI Renderer 1040, Composer 1050 and Model Matcher 1060 are all operating similar to the analogies blocs having same names in FIGS. 3-5, 7 and 9, depending on the supported functionality and features; Similarly, Templates 1030 provides the functionality of Templates and Object Template blocks in these figures. Target Locator 1010, if needed using additional Locators, Trackers and templates types from Templates 1030, locate and direct images sections to Analyzer 1070 that analyze them and help to select specific Models of Selected Object, and if applicable, also adjust the Model Matcher 1060 operations. As opposed to Model of Selected Object in previous figures, FIG. 10 writes Models of Potential Objects. Emphasizing it a bi-directional process of selecting objects from potential ones.

Some of the possible non-limiting example cases supported by the User Platform as described by FIG. 10 include:

Case 1: Linking the continuous scaling options of the 2.5 objects models to the true discreet offered sizes of real objects, as described above according to some embodiments of the present invention. In this case Target Locator 1010 optionally locates a reference object or a measurement element while Analyzer 1060 is used to understand them and accordingly extrapolate relevant sizes, optionally also contribute to the scaling control of the Selected Object model by Model Matcher 1060.

Case 2: Analyzing the user's attributes at the target environment picture and automatically suggesting him objects to augment-on that the system think that are best-fit, based on the desired object type he would like to augment. Some non-limiting examples are:

Suggesting eyeglasses with golden-frame to a bold person or one with dark face skin, or

Suggesting a diamonds ring to a lady who already has rings like that, or

Suggesting a delicate watch to a person with a small hand.

Case 3: An extension of Case 2 above; analyzing the user's attributes at the target environment picture and automatically suggesting him objects to augment-on that the system think that are best-fit, without asking him to select desired objects types he would like to augment. Some examples are:

Suggesting Earrings if earrings are already found on the end-user image;

Suggesting necklaces if the end-user is identified as a woman,

Suggesting Rings if the end-user is identified as a woman.

Case 4: Using a reference image that contains at least one object that the user wishes to find one that is similar to it. This case has two phases—in the first phase the user ‘show’ the system the reference image and the system analyze it to find similar ones, while the second phase is the augmentation based on suggestions similarly to as in cases 2-3 above or showing relevant families of objects as in previous figures:

Phase 1—The user select ‘using-reference’ mode, and photo via Camera 146 a picture of the reference image, showing the target environment at the reference image that contain an objects or objects that he wishes to find similar-to. For example, optionally an image of a celebrity wearing sun glasses, which a user wishes to get similar ones, or an advertisement for hats but showing a person wearing interesting tie. Target Locator 1010 then tries to find relevant objects using templates from Templates 1030, similarly to explained in accordance to previous figures; if needed it then trigger AOI hints asking the user's help through AOI Renderer 140 and Composer 1050, but such mode is typically not be desired if the application is to be fully automatic, and if Target Locator in this case has not identified relevant objects, the user is informed that the process cannot be continued. However, if relevant objects are identified, in Analyzer 1070, that if needed, now has additional analyses capabilities such as shapes hints such as discriminating between square and round watches, can analyze their attributes. The user is then asked to point the camera at the target environment and the platform starts the augmentation process.

Phase 2—The analysis results and hints found by the Analyzer in Phase 1 are used for selecting matching objects models; they are then presented to the user. If more than a single relevant object is discovered and they belong to different types, the user optionally will be asked to first select the desired object type. The augmentation process then proceeds as explained above in some embodiments of this invention.

In Cases 2 and 3 above the user will optionally need to select if he wishes to use an automated suggestions mode; also, in Case 3 above, the user will optionally be first presented with a list of objects types to select from, prior to showing him specific families and objects. In Case 4 above the platform also optionally rank the suggestion sits showing the user by its similarity to the objects at the reference image; in relation to case 4 a reference Video is optionally used instead of a reference image, in such case the Target Location process of Phase 1 will search in at least some of the video sequence images. A similar process to Phase 1 of Case 4 above is optionally migrated to be done by the Items Provider, the Augmented Reality Application Platform provider or the Website Provider, using similar methods to those described above, and the Augmented Reality platform optionally is extended to include the analysis results and hints in the meta data of relevant objects and families, those permitting using it at the User's Platform without needing to go through the complete Phase 1 over there. In relation to Cases 2-4 above suggestions made to the user will optionally considered also statistics gathered by the Augmented Reality Solution over many users having similar issues; for example, it might be found that most popular eyes-glasses frames selected by bold mans are thin and having silver or golden color, or many women that searched for a necklace carefully white-pearls one, and these optionally will be considered in making the suggestion to the end user. Statistics gathering optionally will be used either by analyzing viewed objects patterns such as on-screen average time, or by getting relevant information from the Items Providers themselves, or by other methods; using the statistics optionally will be enabled by including it in the objects and families metadata, or by queries made through the Items Website and the Augmented Reality Application Platform to the Items Provider, or by other way.

Those skilled in the art will readily appreciate that various modifications and changes can be applied to some of the embodiments of the present invention to allow augmenting an object that is based on either 2D or 2.5D or 3D model, while analyzing the user's attributes at the target environment picture and automatically suggesting him objects to augment-on that the system think that are best-fit for him based on his attributes at the target environment, for the purpose of the augmented reality augmentation of objects.

Those skilled in the art will further readily appreciate that various modifications and changes can be applied to some of the embodiments of the present invention to allow augmenting an object that is based on either 2D or 2.5D or 3D model, while analyzing a reference image that contains at least one object that the user wishes to find one and automatically suggesting him objects to augment-on that the system think that are best-fit for him based on his wishes, for the purpose of the augmented reality augmentation of objects.

### Using an Automated Agent:

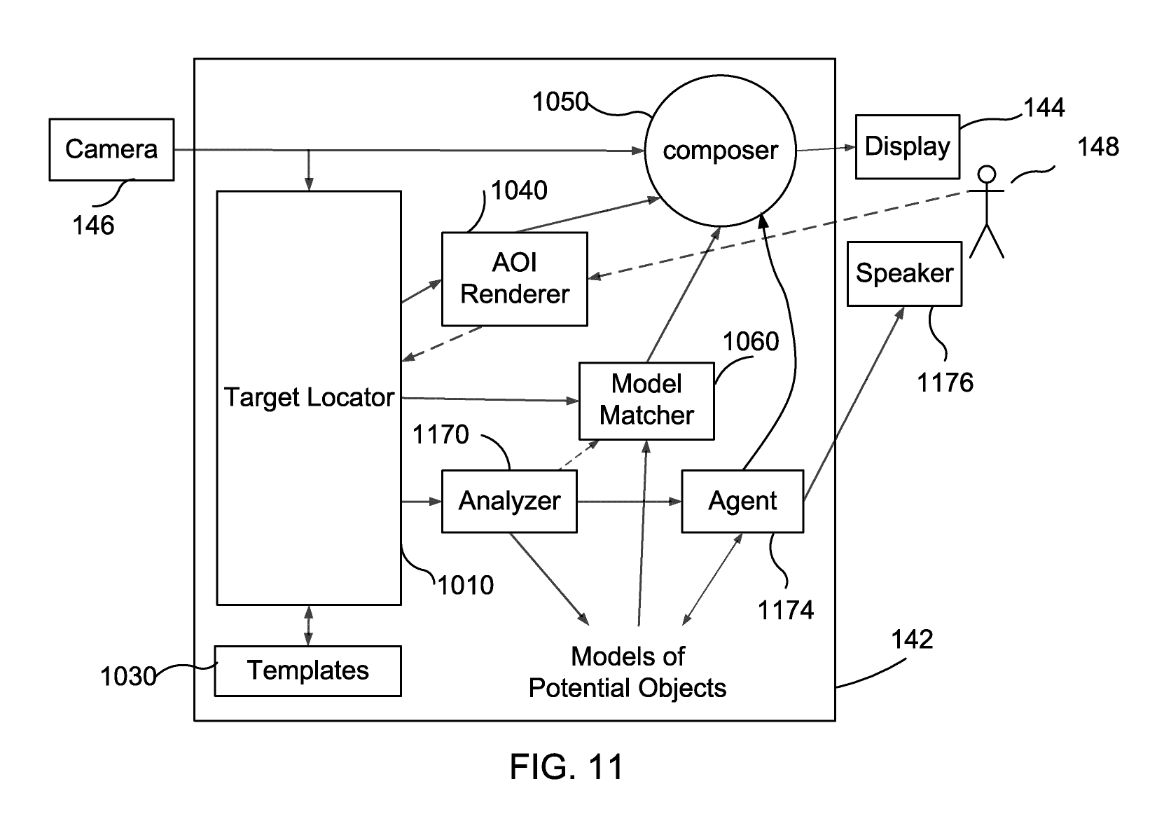

Reference is now made to FIG. 11 which is a simplified block diagram illustration of an AR system according to an example embodiment of the invention. FIG. 11 depicts a schematic illustration of an Augmented Reality User Platform, similar to the Augmented Reality User Platforms as described by FIG. 10, but with an extension that provides an automated agent that is used to promote usage or selling of items using the, according to some embodiments of the present invention. Such agent optionally let the user know an opinion on the fitting of the specific object to his needs and the overall look of it, propose alternatives, etc. Most blocks in FIG. 11 are same or similar to FIG. 10 blocks, and the operation of the User Platform described by FIG. 11 is basically as of the User Platform described by FIG. 10, extended with the Automated Agent functionality; the extended and new blocks appearing in FIG. 11 are:

Analyzer 1170 that is an extension of Analyzer 1070 of FIG. 10, adding its consideration data to help the Agent 1174 superposing its promotions;

Agent 1174 that using analysis results, hints and considerations data from Analyzer 1170 along with meta data related to potential objects proposed to the user, create its promotional data, that is typically put, also by Agent 1174, into a voice form by using Text To Speech or other mechanism; and

Speaker 1176 that is typically an inherent element of any User Platform, and is used to play the Agent promotional sound to the user.

Analyzer 1070 transfer its analysis data, hints and considerations to Agent 1174, as well hints for selecting models of potential objects. Agent 1174 combines the selection along with other info it got from Analyzer 1170, and produces its promotion. Agent 1174 is acting by pre-defined business logic rules. For example, if Analyzer 1170 decides on golden frames for eyeglasses due to their match to persons with light white face skin he say so; furthermore, he will optionally point out the most popular models selected by such persons. The promotions of Agent 1174 optionally will alternatively or additionally be expressed visually, by superposing data through Composer 1050, as the dotted line between them indicates.

### Using a Remote Camera:

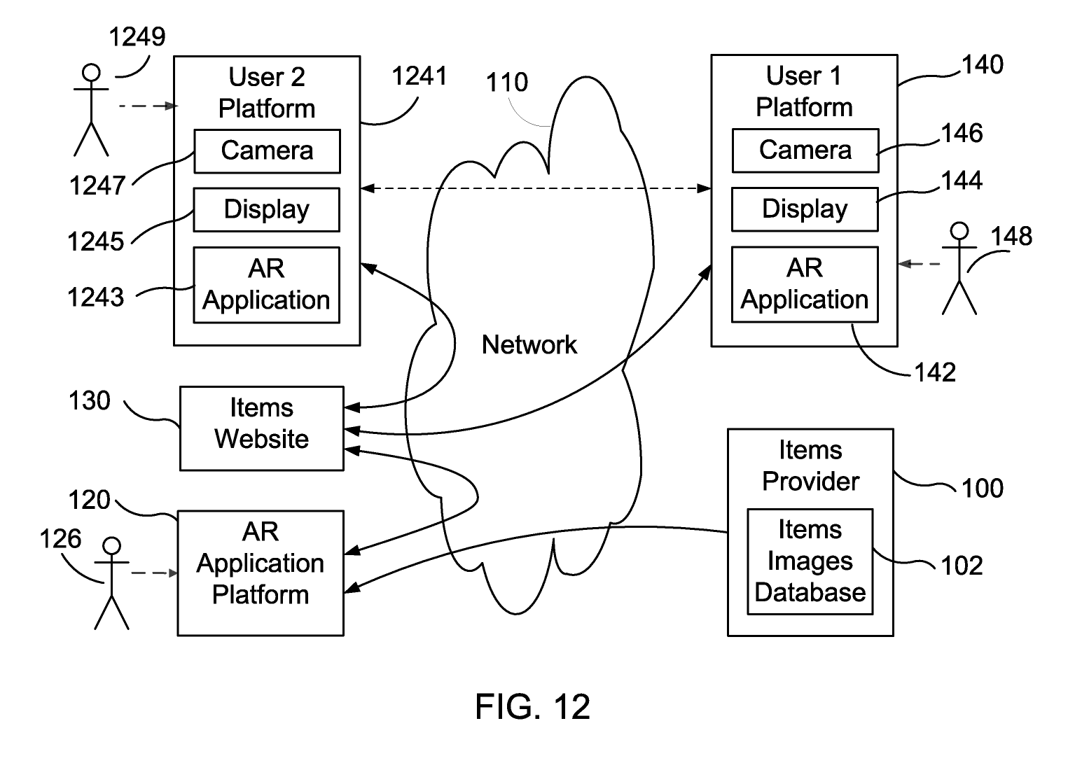

Reference is now made to FIG. 12 which is a simplified block diagram illustration of a system for distributed Augmented Reality applications according to an example embodiment of the invention. FIG. 12 depicts a schematic illustration of an Augmented Reality system with boosted efficiency similar to the Augmented Reality system presented in FIG. 1C of this invention and therefore most of the descriptions will not be repeated in here, but with extensions that allows usage of items seen by a remote camera that captures items that are desired to be augmented over an image or live video, according to some embodiments of the present invention. An exemplary usage is on which a person A sees eye glasses or a watch in the store, and using an application on his mobile phone, communicate the object images to the Augmented Reality platform via a server, allows person B that also communicates the Augmented Reality platform to see the object augmented over his face or hand, accordingly; another example is using direct communication between the two persons using for that only the mobile network and web infrastructures, simulated by the dotted line between them, in which Pearson A initiate a Video call to Person B, while the Augmented Reality Application on Person B User's Platform extract from the video call the desired object and augment is on the target environment image or Video as needed; in a further example similar to the previous one, the Video call is routed through a server that is part of the Augmented Reality solution. FIG. 12 is similar to FIG. 1C, and analogues blocks are indicated by same numbers, while for the sack of simplicity the sub-blocs of Items Provider 100 and Augmented Reality Application Platform 120 are not presented by FIG. 12. User Platform 140 of FIG. 1C is named in FIG. 12 User 1 Platform to indicate it is used by User 148 that is the end user that views the augmented reality result, i.e. user B in the above examples. A new block in FIG. 12 that do not appears in FIG. 1C is User 2 Platform 1241, used by the remote user, i.e. user A in the above examples, that is using the remote camera that capture the items that are desired to be augmented and viewed over User 1 Platform.

User 2 Platform is used by User 1249 comprising Augmented Reality Application 1243, Display 1245 and Camera 1247. Depending on the exact case, some of the blocks are not needed for the Augmented Reality System process and optionally will be redundant; similarly, Augmented Reality Application 1243 will optionally have functionalities as needed and if needed similar to as described in relation to Augmented Reality application in previous figures, depending on the specific case, such as, such as identifying objects by using templates; further similar, User 1 Platform 140 Augmented Reality Application 142 has functionality as needed and per need similar to as described in relation to Augmented Reality application in previous figures.

Some non-limiting example cases supported by the Augmented Reality System as described by FIG. 12 include:

Case 1: User 2 Platform captures the desired objet image, Augmented Reality Application 1243 identify it with the help of relevant templates and send the result to Items Website 130, that finds the model of the exact object or a similar one, and instruct Augmented Reality Application 142 at User 1 Platform 140 to use it as the model of selected object and augment it at the target place over the target environment as seen by Camera 146 of User 1 Platform, showing the result to User 148 over Display 144.

Case 2: Similar to Case 1 but a family of selected objects similar to the one captured by user 1249 is shown as potential objects to user 148 of which he needs to select an object for the augmentation, if he find such that he wishes to.

Case 3: Similar to cases 1 and 2 but wherein the analysis is done by relevant modules extending Augmented Reality Application Platform 120.

Case 4: Similar to cases 1 and 2 but wherein the analysis is done by User Platform 1.

Case 5: Similar to Case 1 but no relevant object is identified and therefore the object is just extracted by User 2 Platform and therefore is limited in its superposition for the augmentation by User 1 Platform.

Case 6: Similar to Case 5 but relevant type is identified and allow adding to the extracted object image, artificial relevant information on depth, those creating a 2.5.D model.

Case 7: Similar to all above cases but in which just the images captured by User 2 Platform is delivered to User 1 Platform that carries on remaining task, if need with the help of Items Website 130 and Augmented Reality Application Platform 120. Optionally, the communication between the two user's platforms optionally will be done using a Video Call; the Video call will optionally be routed through network resources such as Operator's Video calls servers, or alternatively through additional servers of the Augmented Reality System but not shown in the diagrams.

Regarding Case 3 and Case 7 above, in some embodiments an Augmented Reality Application is not used at User 2 Platform; in such cases, being able to communicate images or Video is sufficient.

In the above cases, the augmentation result will optionally be communicated as an image or a video, optionally using a video call, and shown back also to user 1249, optionally allowing him to express his opinion on the result back to user 148, either using remarks over the image that user 148 view or using voice up to even a voice chat, or any other alternative such as textual chat or any mix of chats. In a further extension the result will optionally be communicated as an image or video, to other persons that will optionally express their opinion, those having also social network characteristics. It is a known method that using a remote camera systems as described by some embodiments of the current invention is suitable to be implemented by mobile communication devices such as mobile phones, especially in serving as User 2 Platform as the nature of remote capturing means is calling for.

It is understood that the invention is not necessarily limited in its application to the particular details set forth in the description contained herein or illustrated in the drawings. The invention is capable of other embodiments and of being practiced and carried out in various ways. Hence, it is to be understood that the phraseology and terminology employed herein are for the purpose of description and should not be regarded as necessarily limiting.

Those skilled in the art will readily appreciate that various modifications and changes can be applied to the embodiments of the invention as herein before described without departing from its scope, defined in and by appended claims.

In the above detailed description, numerous specific details are set forth in order to provide a thorough understanding of the invention. However, it will be understood by those skilled in the art that the present invention may be practiced without some of the details.

It is expected that during the life of a patent maturing from this application many relevant systems and methods will be developed and the scope of the term a module, environment, a network, a user platform and a mobile communication device is intended to include all such new technologies a priori. An example is usage of 3D cameras and potentially also full 3D models of objects created by them.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method for superposing an image of an object onto an image of a scene, comprising:
obtaining a 2.5D representation of the object;
obtaining the image of the scene;
obtaining a location in the image of the scene for superposing the image of the object;
producing the image of the object, suitable for superposing at the location, using the 2.5D representation of the object; and
superposing the image of the object onto the image of the scene, at the location.

2. The method of claim 1 in which the obtaining the 2.5D representation of the object comprises capturing a plurality of photo-realistic images of the object taken from different angles to the object, and producing the 2.5D representation of the object based on the plurality of images.

3. The method of claim 2 in which the obtaining a 2.5D representation of the object further comprises extracting from at least some of the plurality of photo-realistic images of the object only portions of the plurality of photo-realistic images which include the object.

4. The method of claim 3 in which the extracting comprises a human operator assisting the extracting.

5. The method of claim 1 in which the obtaining a location in the image of the scene for superposing the image of the object comprises using templates characteristic of the location.

6. The method of claim 1 in which the image of the scene is produced from a 2.5D representation of the scene.

7. The method of claim 1 in which the image of the scene is comprised in a video.

8. The method of claim 1 in which the image of the scene is produced by a camera at a user location, and wherein the obtaining the image of the scene comprises the user uploading the image of the scene.

9. The method of claim 7 in which:
the obtaining a location in the image of the scene for superposing the image of the object comprises tracking the location in a plurality of video frames in the video sequence; and
the superposing comprises superposing a plurality of images of the object onto the plurality of video frames in the video sequence at the location in at least some of the plurality of video frames.

10. The method of claim 9 in which the superposing the image of the object comprises producing an animation of a plurality of images of the object and superposing the animation onto the plurality of video frames.

11. The method of claim 3 in which the obtaining a 2.5D representation of the object further comprises stitching the portions into the 2.5D representation of the object, wherein the stitching the portions comprises detecting corresponding locations in the portions of the plurality of photo-realistic images of the object.

12. The method of claim 1 in which the obtaining a 2.5D representation of the object comprises:
a user using a device comprising a camera and a computing unit to:
capture a plurality of images of the object taken from different directions to the object;
produce the 2.5D representation of the object based on the plurality of images; and
the user uploading the 2.5D representation to a computer.

13. The method of claim 1 in which the obtaining a location in the image of the scene comprises:
automatically identifying occlusion of at least a portion of the location; and
overcoming the occlusion using templates characteristic of the location.

14. The method of claim 1 in which the location in the image of the scene is a location of an object in the image of the scene similar to the object the image of which is to be superposed.

15. The method of claim 14 in which, if the image of the object which is to be superposed does not cover all of the similar object in the image of the scene then portions which are not covered are painted by merging to neighboring areas in the image of the scene.

16. A method for online commerce via the Internet, comprising:
obtaining an image of an object for display;
obtaining an image of a scene suitable for including the image of the object for display; and
superposing the image of the object for display onto the image of the scene,
wherein the image of the object for display is produced from a 2.5D representation of the object.

17. The method of claim 16 in which obtaining the image of the object for display comprises selecting the image of the object for display from a catalog of images of objects.

18. The method of claim 16 in which obtaining the image of the scene comprises a user uploading the image of the scene.

19. A method for online commerce comprising:
a user selecting an object for sale from a computerized catalog of objects;
a computer providing an image of the object;
a user uploading a video of a scene suitable for including the image of the object; and
superposing the image of the object onto the image of the scene,
wherein the image of the object is produced from a 2.5D representation of the object.

20. A method of producing a catalog of 2.5D representations of objects comprising:
obtaining a plurality of photo-realistic images of the objects taken from different angles to the objects;
producing the 2.5D representations of the objects based on the plurality of images; and
storing the 2.5D representations of the objects as a catalog.
